(19) United States
(12) Patent Application Publication
(10) Pub. No.: US 2011/0195754 A1
(43) Pub. Date: Aug. 11, 2011

(54) MOBILE ELECTRONIC DEVICE

(75) Inventors: Akira Aoshima, Kanagawa (JP); Kenichi Matsui, Kanagawa (JP); Shuji Ishikawa, Kanagawa (JP); Atsushi Matsumoto, Kanagawa (JP)

(73) Assignee: KYOCERA CORPORATION, Kyoto (JP)

(21) Appl. No.: 13/060,989

(22) PCT Filed: Aug. 27, 2009
(86) PCT No.: PCT/JP2009/064991

§ 371 Date: Feb. 25, 2011

(30) Foreign Application Priority Data
Aug. 28, 2008 (JP) 2008-220572
Oct. 29, 2008 (JP) 2008-277800
Oct. 29, 2008 (JP) 2008-278590

(51) Int. Cl. H04W 88/02

(52) U.S. Cl. 455/566; 455/550.1

(57) ABSTRACT

Provided is a mobile electronic device which enables a user to easily and intuitionally perform an application start operation in accordance with a user's preference. The mobile electronic device includes: an application execution unit (201); an operation unit (202) having an operation key group (11) and a rotary dial unit (41); and an operation control unit (203) for controlling various processes accompanying an operation through the operation unit (202). When a predetermined application is being executed by the application execution unit (201), the operation control unit (203) allocates a processing function relating to the predetermined application to a plurality of setting positions of the rotary dial unit (41). Upon detection of an input through the operation key group (11) while a predetermined application is being executed, the application execution unit (201) executes the processing function allocated to a predetermined setting position of the rotary dial unit (41).

### TECHNICAL FIELD

The present invention relates to a mobile electronic device having an external operation unit and a mobile electronic device having a function to start an application.

### BACKGROUND ART

In mobile phones, there is a demand for a more intuitive user interface. Here, a folding type mobile phone having a hinge portion that is provided with a rotary dial used for a volume change or the like at a hinge portion is known (for example, refer to Patent Document 1).

In addition, the mobile phone is multi-functionalized in that it has not only the function of communication and a voice call but a function of viewing and listening to television and radio. Here, when functions such as television viewing function are not selected in a mobile phone, a standby screen for communication and voice call is displayed as the top screen. Then, it is possible to select a desired function by changing from the standby screen to the menu selection screen for selecting other functions by performing a predetermined operation by the user and performing a predetermined operation in the selection menu screen.

In addition, when starting an application in a mobile phone or the like as the mobile electronic device, by selecting a menu of icons or the like that is displayed on a display unit with an operation at an operation unit, or by associating keys that constitute the operation unit and the applications, the application associated with the key is started upon pressing down the corresponding key. At this time, the application that was previously started is suspended or ended.

Accordingly, as a technique for displaying a screen of an application without starting the application, a mobile phone has been proposed that can confirm the details of the application by saving a past image of when the application was running and displaying the saved image on a display unit (for example, refer to Patent Document 2).

[Patent Document 1] Japanese Unexamined Patent Application, Publication No. H06-90200

[Patent Document 2] Japanese Unexamined Patent Application, Publication No. 2005-293354

### DISCLOSURE OF THE INVENTION

### Problems to be Solved by the Invention

However, since a selection menu that consists of many items is displayed in the menu selection screen, a user unfamiliar with the operation, for example, is likely to feel reluctance towards such a menu selection screen.

In addition, when selecting various menu items when an application is running, it is necessary to perform the operation after starting the menu function with an operation of a soft key (so-called ten-keys) or the like, thereby degrading operability.

In addition, as a utilization form of such a rotary dial, a form can be envisioned in which a predetermined application is run by assigning the predetermined application in advance to the rotary dial and operating the rotary dial.

Meanwhile, in a mobile phone configured as such, a situation is envisioned where a predetermined application (hereinafter referred to as “Application A”) is started by operating the rotary dial and a different application (hereinafter referred to as “Application B”) is started from the started application without the accompanying operation by the rotary dial unit. When such a situation takes place, if Application B that is identical to Application B currently running in the foreground is selected by the operation of the rotary dial, Application B that is currently running in the foreground is ended and the state returns to the standby state, and thereafter, the selected Application B is started again.

However, since a past screen of the application is displayed in the technique proposed in Patent Document 2, such a screen may be inappropriate as a screen for an application in which the contents displayed on the screen change every time the application is started, for example.

In addition, when the application is controlled to start consecutively according to the operations at the operation unit, there is a possibility of hindering the operability of the mobile phone by taking time in starting and suspending the application.

### Means for Solving the Problems

In order to solve the above problems, the mobile electronic device according to the present invention includes an application execution unit; an operation means having an input operation unit and an external operation unit; and an operation control means for controlling various processing associated with operation by the operation means; in which, when a predetermined application is being executed by the application execution unit, the operation control means assigns processing functions related to the predetermined application to a plurality of setting positions in the external operation unit; and when an input by the input operation unit is detected at a time when the predetermined application is being executed, the application execution unit executes the processing function allocated to the predetermined setting position in the external operation unit.

Moreover, the mobile electronic device preferably includes a display control unit for controlling a display unit, in which, when a predetermined application is being executed by the application execution unit, the display control unit displays display information of the processing function assigned to the external operation unit.

Moreover, it is preferable if information of the processing function assigned to the predetermined application is displayed on an external surface of the external operation unit.

Moreover, the mobile electronic device preferably includes a display unit, in which, when the predetermined application is being executed, the operation control means assigns a processing function corresponding to an image displayed on the display unit to the setting position of the external operation unit.

Moreover, the mobile electronic device preferably includes a communication unit, in which, when the predetermined application is being executed and information of a predetermined other communication party is selected, the operation control means assigns a processing function related to a communications processing performed by the communication unit to the predetermined other communication party to the setting position of the external operation unit.

Moreover, it is preferable if information of the processing function assigned to the predetermined application is displayed on external surface of the external operation unit.

Moreover, the mobile electronic device preferably includes a display unit, in which, when the predetermined application is being executed, the operation control means assigns a processing function corresponding to an image displayed on the display unit to the setting position of the external operation unit.

Moreover, the mobile electronic device preferably includes a communication unit, in which, when the predetermined application is being executed and information of a predetermined other communication party is selected, the operation control means assigns the processing function related to a communications processing performed by the communication unit to the predetermined other communication party to the setting position of the external operation unit.

Moreover, it is preferable if when an application of character inputting is being executed, the operation control means assigns a processing function related to character inputting to the setting position of the external operation unit.

In order to solve the above problems, the mobile electronic device according to the present invention includes a housing; a rotary dial unit attached to the housing rotatably about a predetermined revolving shaft; a rotation amount detection unit for detecting rotation amount of the rotary dial unit; an application starting processing unit for determining and starting one application among a plurality of applications based on the rotation detected by the rotation amount detection unit; and an application execution determination unit for determining whether or not the application determined by the application starting processing unit has been executed; in which, when it is determined by the application starting determination unit that the application determined by the application starting processing unit has been executed, the application starting processing unit stops the start of the application.

Moreover, it is preferable if, in a case where it is determined by the application execution determination unit that the application determined by the application starting processing unit is running in background when a plurality of the applications are running, the application starting processing unit stops the start of the application, switches the application that is running in background to run in foreground, and switches another application that had been running in foreground to run in background.

In order to solve the above problems, the mobile electronic device according to the present invention includes an operation unit; a display unit; an operation detection unit for detecting operation of the operation unit; a storage unit for storing information of a display screen for each application that is displayed on the display; and a control unit for controlling, when a first operation for selecting the application is detected by the operation detection unit, to acquire information of the display screen of the application by referring to the storage unit and to display the display screen on the display unit with the acquired information.

Moreover, the mobile electronic device preferably includes an application control unit for controlling, when a second operation for starting the application is detected after the first operation has been detected by the operation detection unit, to start the application by removing information of the display screen from the application.

Moreover, it is preferable if the information of the display screen of the application that is stored in the storage unit is information of a starting screen that is displayed when the application is started.

In order to solve the above problems, the mobile electronic device according to the present invention includes a housing; a display unit arranged at the housing; a rotary dial unit which is arranged at the housing and is rotatable about a predetermined revolving shaft; a rotation amount detection unit for detecting a rotation amount of the rotary dial unit; a storage unit for storing information of a display screen for each application that is displayed on the display unit; and a control unit for controlling, when a first rotation amount for selecting the application is detected by the rotation amount detection unit, to acquire information of the display screen of the application by referring to the storage unit and to display on the display unit the acquired information of the display screen.

Moreover, the mobile electronic device preferably includes an operation unit; an operation detection unit for detecting operation of the operation unit; and an application control unit for controlling, when a third operation for operating the application is detected by the operation detection unit after the first rotation amount is detected by the rotation amount detection unit, to operate the application by removing information of the display screen from the application.

Moreover, it is preferable if the information of the display screen of the application that is stored in the storage unit when the third operation is detected is information of a starting screen that is displayed first when the application is started.

Moreover, the mobile electronic device preferably further includes: a display screen information storage unit for storing temporarily information of the display screen displayed on the display; and a processing unit for performing predetermined processing; in which the application control unit operates a new application according to the predetermined processing by the processing unit, and the control unit displays on the display unit information of a display screen of the new application instead of information of the display screen of the application according to the operation of the new application, and stores information of the display screen of the application in the display screen information storage unit.

Moreover, it is preferable if, when the application control unit ends the new application in response to terminating the predetermined processing by the processing unit, the control unit displays on the display unit information of the display screen of the application by referring to the display screen information storage unit.

Moreover, it is preferable if, when the application control unit operates the new application, the information of the display screen of the application that is stored in the display screen information storage unit is information of a display screen of the application that had been displayed on the display unit immediately before the display screen of the new application is displayed.

### EFFECTS OF THE INVENTION

According to the present invention, operation of an application currently performed according to the preference of the user can be performed simply and intuitively.

In addition, according to the present invention, processing that conflicts with the application can be avoided and usability can be improved.

In addition, according to the present invention, the mobile electronic device which can display the display screen of the application virtually can be provided.

### BRIEF DESCRIPTION OF THE DRAWINGS

FIG. 1 is a drawing showing an external view of a mobile phone according to the present invention.

FIG. 2 is a drawing showing an external view of a mobile phone in a closed state when seen from a display unit side housing portion.

FIG. 3 is a drawing showing an external view of a mobile phone in the closed state when seen from the operation unit side housing portion.

FIG. 4 is a drawing near the rotary dial unit when it is expanded.

FIG. 5 is a drawing for illustrating the function of the rotary dial unit.

FIG. 6 is a functional block diagram showing the function of a mobile phone.

FIG. 7 is a flow chart for illustrating the selection operation of various kinds of applications and the menu that is performed using the rotary dial unit.

FIG. 8 is a flow chart for illustrating the detailed operation of the processing unit when a rotation operation of the rotary dial unit is performed when a camera function is selected in the process in step S4 in the flow chart shown in FIG. 7.

FIG. 9 is a schematic diagram showing the content of the table that is referred to when a rotation operation of the rotary dial unit is performed when the camera function is running and a preview is displayed before shooting.

FIG. 10 is a schematic diagram showing the content of the table that is referred to when the rotary dial unit is operated when the camera function is started.

FIG. 11 is a flow chart for illustrating the detailed operation of the processing unit when a rotation operation of the rotary dial unit is performed when a data folder function is selected in the process in step S13 in the flow chart shown in FIG. 7.

FIG. 12 is a schematic diagram showing the content of the table that is referred to when a rotation operation of the rotary dial unit is performed while the data folder function is running.

FIG. 13 is a schematic diagram showing the content of the table that is referred to when the rotary dial unit is operated when a mail function is selected in the process in step S5 in the flow chart shown in FIG. 7.

FIG. 14 is a schematic diagram showing the content of the table that is referred to when the rotary dial unit is operated when a calendar function is selected in the process in step S7 in the flow chart shown in FIG. 7.

FIG. 15 is a schematic diagram showing the content of the table that is referred to when the rotary dial unit is operated when an address book function is selected in the process in step S15 in the flow chart shown in FIG. 7.

FIG. 16 is a flow chart for illustrating a method of editing in a text editor using the rotary dial unit.

FIG. 17 is a schematic diagram showing the content of the table that is referred to when the rotary dial unit is operated when the text editor is started.

FIG. 18 is a drawing for illustrating the function of the rotary dial unit according to a second embodiment.

FIG. 19 is a functional block diagram showing the function of the mobile phone according to the second embodiment.

FIG. 20 is a flow chart for illustrating specific operation of the processing unit of the mobile phone according to the second embodiment (operation for avoiding conflicts among applications).

FIG. 21 is a drawing for illustrating the function of the rotary dial unit according to a third embodiment.

FIG. 22 is a functional block diagram showing the function of the mobile phone according to the third embodiment.

FIG. 23 is a functional block diagram showing the function of the processing unit provided in the mobile phone according to the third embodiment.

FIG. 24 is a drawing showing an example of information of the starting screen of the application stored in the storage unit according to the third embodiment.

FIG. 25 is a sequence diagram showing the flow of processing by the mobile phone according to the third embodiment.

FIG. 26 is a sequence diagram showing the flow of processing by the mobile phone according to the third embodiment.

FIG. 27 is a flow chart showing the flow of processing of the mobile phone according to the third embodiment.

### PREFERRED MODE FOR CARRYING OUT THE INVENTION

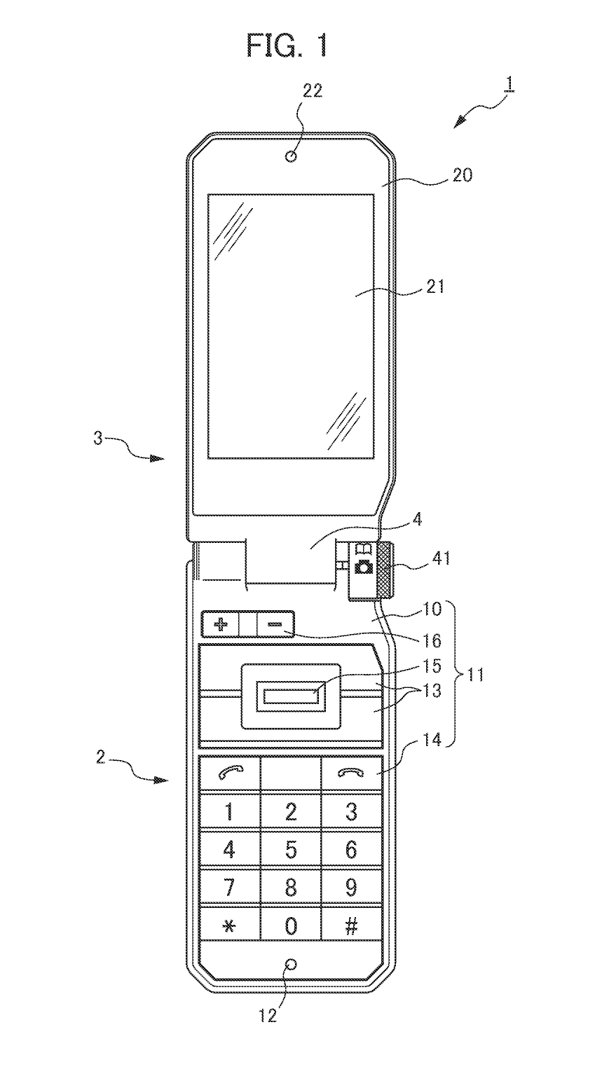

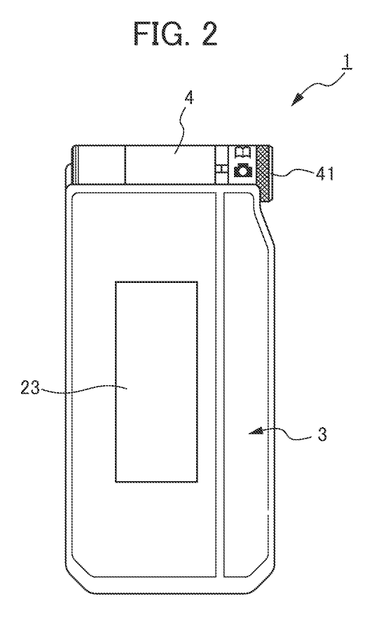

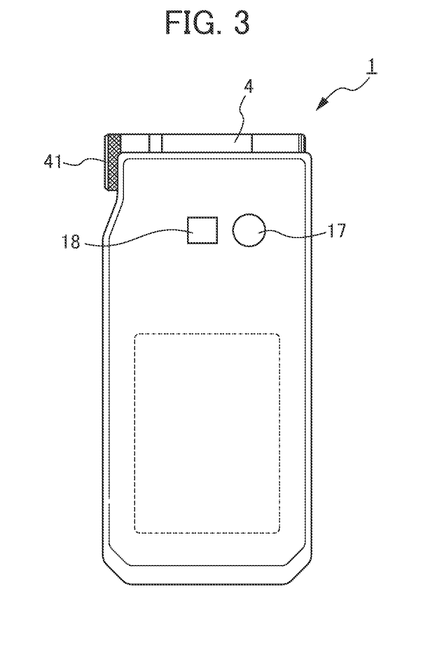

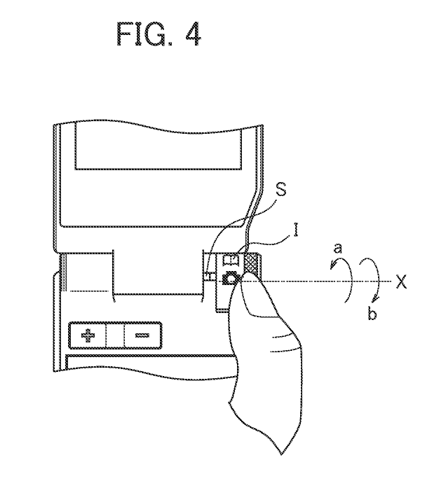

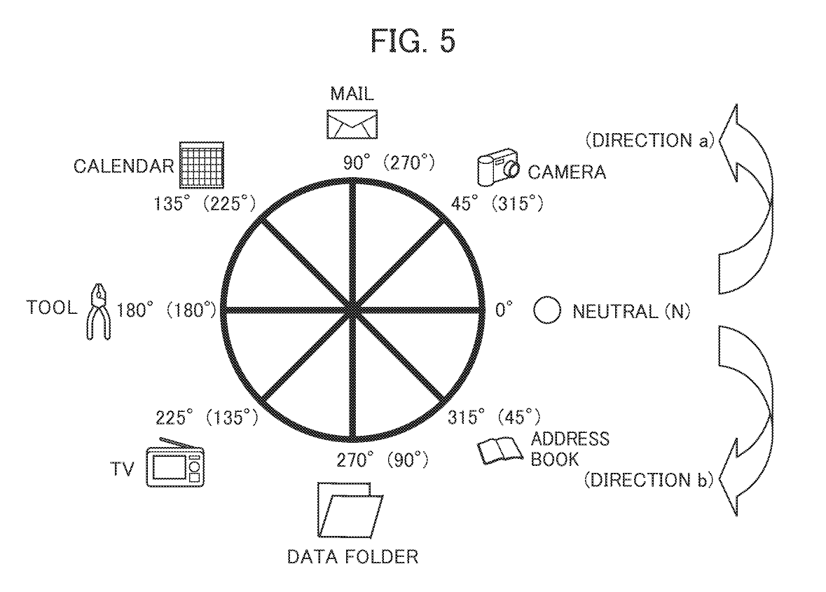

Hereafter, embodiments of the present invention will be described. FIG. 1 shows an external perspective view of a mobile phone 1 which is an example of the mobile electronic device according to the present invention. In addition, FIG. 2 shows an external view of the mobile phone 1 in the closed state when seen from the display unit side housing portion 3. In addition, FIG. 3 shows an external view of the mobile phone 1 in the closed state when seen from the operation unit side housing portion 2. In addition, FIG. 4 shows an enlarged view near the rotary dial unit that serves as an external operation unit. In addition, FIG. 5 is a drawing showing the function of the rotary dial unit. It should be noted that although the present invention will be described below with respect to mobile phones, the present invention is not limited thereto and may be PHS (Personal Handy phone System), PDA (Personal Digital Assistant), portable navigation device, notebook PC and the like as long as it has an external operation unit such as a rotary dial unit and is capable of starting a plurality of applications independently.

As shown in FIG. 1, the mobile phone 1 is configured to include an operation unit side housing portion 2 and a display unit side housing portion 3. The operation unit side housing portion 2 is configured to include on the surface portion 10 an operation key group 11 and a microphone 12 into which voice uttered by the user of the mobile phone 1 at the time of a voice call is inputted. The operation key group 11 is constituted by function setting operation buttons 13, input operation buttons 14, a determination operation button 15, and control buttons 16. The function setting operation buttons 13 are buttons for executing various functions such as various settings, telephone directory functions, and mail function. The input operation buttons 14 are buttons for inputting numbers in telephone numbers and characters and the like of mail and the like The determination operation button 15 is a button that performs determination, scroll, and the like in various operations. The control buttons 16 are buttons that performs volume control or the like.

In addition, the display unit side housing portion 3 is configured to include on the surface portion 20 a display 21 for displaying a variety of information, and a voice output unit 22 which outputs the voice of the other party of a voice call.

In addition, the upper end of the operation unit side housing portion 2 and the lower end of the display unit side housing portion 3 are connected via a hinge mechanism 4. In addition, by rotating relatively the operation unit side housing portion 2 and the display unit side housing portion 3 that are connected through the hinge mechanism 4, the mobile phone 1 can bring the operation unit side housing portion 2 and the display unit side housing portion 3 into the state where they are opened with each other (open state), can bring the operation unit side housing portion 2 and the display unit side housing portion 3 into the state where they are folded (closed state).

It should be noted that although FIG. 1 shows an embodiment of a so-called folding type mobile phone 1, the embodiment of the mobile phone 1 according to the present invention is not limited to this in particular, and may be a sliding type in which one of the housings of the operation unit side housing portion 2 and the display unit side housing portion 3 slides in a direction from an overlapped state, a revolving type (turn type) in which one of the housings of the operation unit side housing portion 2 and the display unit side housing portion 3 is rotated about an axis along their overlapping direction, a type (straight type) in which the operation unit side housing portion 2 and the display unit side housing portion 3 are arranged in one housing and there is no connection portion, and the like.

In addition, in the position where the hinge mechanism 4 is formed, there is provided a rotary dial unit 41 that serves as an external operation unit attached to the housing so as to rotate freely in a predetermined direction. It should be noted that the operation and the function of the rotary dial unit 41 will be described later. In addition, the external operation unit may be a configuration other than the rotary dial unit 41, and it is suitable as long as it is arranged separate from the input operation buttons 14 or the determination operation button 15 that are for performing the input operation, the selection operation, and the determination operation and is arranged outside of the housing.

In addition, as shown in FIG. 2, at the rear face side where the display 21 of the display unit side housing portion 3 is arranged, the mobile phone 1 includes a sub display 23 where predetermined information is displayed.

In addition, as shown in FIG. 3, at the rear face side where the operation key group 11 of the operation unit side housing portion 2 is arranged, the mobile phone 1 includes an imaging unit 17 constituted with a CCD (Charge Coupled Device) camera that shoots a photographic subject, and a light emitting unit 18 which outputs a certain amount of light.

Here, the operation and the function of the rotary dial unit 41 will be described. As shown in FIG. 4, the rotary dial unit 41 is attached to the housing along the revolving shaft X of the hinge mechanism 4 so that it rotates freely in a predetermined direction (Direction a (a first direction that intersects perpendicularly with the revolving shaft of the hinge mechanism 4) and Direction b (a second direction that intersects perpendicularly with the revolving shaft of the hinge mechanism 4) in FIG. 2) with a finger of the user. It should be noted that the rotary dial unit 41 is not limited to the arrangement shown in FIG. 4, and is suitable as long as it has an arrangement freely rotatable by the operation of the user, and may have an arrangement that rotates freely in a predetermined direction along an axis of the direction that intersects perpendicularly with the revolving shaft (hinge shaft) X.

In addition, at the rotary dial unit 41, a plurality of indices (icon) I are attached at intervals of predetermined spacing in the direction of rotation. It should be noted that the indices I are drawn with images that are easy to be understood by the user, such as images that would serve as guides when selecting an application, for example, as shown in FIG. 5.

Here, the operation of the rotary dial unit 41 by the user will be briefly described. With the indices I serving as the guide, the user rotates the index I that corresponds to the desired application to a selected position (guide) S shown with a mark or the like on the external surface of the case of the hinge mechanism 4. The mobile phone 1 starts an application that corresponds to the index I that remains stationary at the selected position S (guide). Thereby, with the rotary dial unit 41, it is possible to perform the menu selection that brings out various kinds of functions by the operation of the physical rotary dial.

In addition, the rotary dial unit 41 can perform the menu selection that brings out various kinds of functions according to the operation of the physical rotary dial. As shown in FIG. 5, for example, the camera function of the imaging unit 17 is started by the rotary dial unit 41 being rotated 45 degrees to Direction a (315 degrees to direction b) and the function of mail is started by the rotary dial unit 41 being rotated 90 degrees to Direction a (270 degrees to direction b), from a non-operated situation (neutral (N)). Moreover, the calendar function is started by the rotary dial unit 41 being rotated 135 degrees to Direction a (225 degrees to direction b), and a tool menu (a menu for performing various kinds of settings such as those relating to sound output in the mobile phone 1) is started by the rotary dial unit 41 being rotated 180 degrees to Direction a (180 degrees to direction b) from the non-operating situation (N). Moreover, the television function is started by the rotary dial unit 41 being rotated 225 degrees to Direction a (135 degrees to direction b), a data folder is started by the rotary dial unit 41 being rotated 270 degrees to Direction a (90 degrees to direction b), and an address book is started by the rotary dial unit 41 being rotated 315 degrees to Direction a (45 degrees to direction b) from the non-operating situation (N).

It should be noted that the menu assigned according to the rotation angle of the rotary dial unit 41 described above is merely an example and is not limited to this, and may have a configuration in which the menu that the user itself uses frequently can be registered, for example, and may have a configuration in which a web browser is started and a web page of a desired web address can be browsed by registering the desired web address and selecting the web address by the rotary dial unit 41. In addition, the number of menus is also not limited to the above number (seven).

In addition, by operating the rotary dial unit 41 directly, the user can directly start various functions that are assigned to the rotary dial unit 41, under a certain condition, and it is not necessary to start via the main menu as in a conventional way, and it is possible to start the desired application simply.

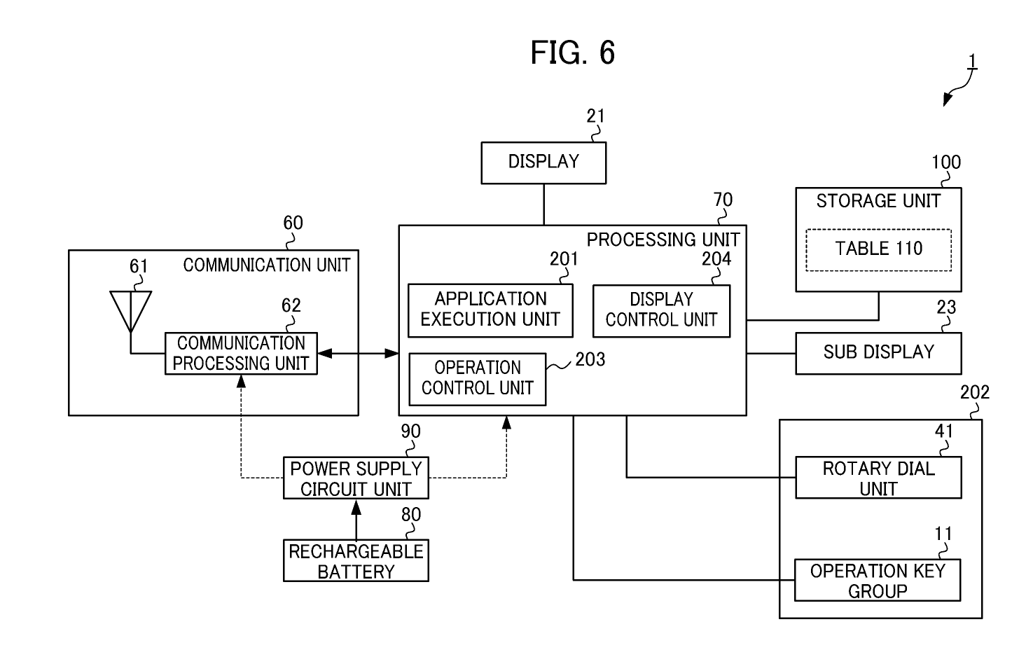

In addition, FIG. 6 is a functional block diagram showing the function of the mobile phone 1. As shown in FIG. 6, the mobile phone 1 includes a display 21 which is not externally exposed when in a closed state, which serves as the display unit, and a sub display 23 which is externally exposed even in the closed state. Furthermore, the mobile phone 1 includes the rotary dial unit 41 which is rotated by the operation of the user, a communication unit 60 for communicating with external terminals, a processing unit 70 which performs predetermined processing, a rechargeable battery 80 having a predetermined capacity, a power supply circuit unit 90 which converts the power supply voltage supplied from the rechargeable battery 80 to a predetermined voltage and supplies the voltage that underwent conversion to the communication unit 60, the processing unit 70 and the like, and a storage unit 100 having a table 101.

The communication unit 60 has a main antenna 61 for communicating with external devices with a predetermined utilizing frequency band, and a communication processing unit 62 which performs signal processing such as modulation processing and demodulation processing.

The main antenna 61 communicates with external devices (base stations) with a predetermined utilizing frequency band (for example, 800 MHz). It should be noted that although the predetermined utilizing frequency band in the present embodiment is 800 MHz, frequency bands other than this may be used. The main antenna 61 may have a configuration of so-called dual band supported type which can support a second utilizing frequency band (for example, 2 GHz) besides the predetermined utilizing frequency band, and further, may be configured with a multiple band supported type which can also support at least a third utilizing frequency band.

The communication processing unit 62 performs demodulation processing of the signal received by the main antenna 61, and supplies the signal that underwent the processing to the processing unit 70 and meanwhile performs modulation processing of the signal supplied from the processing unit 70 and transmits it to external devices (base stations) via the main antenna 61.

The power supply circuit unit 90 transforms the power supply voltage supplied from the rechargeable battery 80 to a predetermined voltage value, and supplies the power supply voltage that underwent the transformation to the communication unit 60, the processing unit 70 or the like.

Many programs that are executed at the processing unit 70, parameters, various tables, and the like are stored in the storage unit 100. Specifically, the storage unit 100 stores many application programs that are started, ended, suspended and the like at the processing unit 70, parameters used in those plurality of the applications, OS (Operating System) programs for operating the plurality of application programs, and the correspondence relationship between the rotation amount detected by the rotation detection unit 71 (see FIG. 5.), as well and furthermore, a table 110 showing whether or not there is an application that can be started in the closed state. It should be noted that the plurality of application programs includes a standard application, an image playback application, and the application programs for each application that the mobile phone 1 has such as camera and mail.

The processing unit 70 performs starting processing for various functions according to the rotation amount supplied from the rotary dial unit 41. Here, the configuration and the operation of the processing unit 70 will be described. The processing unit 70 detects the rotation amount of the rotary dial unit 41, starts a predetermined application according to the detected rotation amount, and controls to display a display screen corresponding to the started predetermined application on the display 21. It should be noted that although the amount of change in the angle of the rotary dial unit 41 is detected as the rotation amount in the present embodiment, the present invention is not limited to this, and it is suitable as long as the change according to the rotation of the rotary dial unit 41 can be detected, and for example, the change in resistivity or the like may be detected as the rotation amount. Alternatively, a rotation position (or rotation angle) of the rotary dial unit 41 may be detected to perform control according to the detected rotation position.

In addition, the processing unit 70 refers to the table 110 of the application correspondence relationship in the storage unit 100 whenever the rotation amount of the rotary dial unit 41 takes place and identifies an application according to the rotation amount. It should be noted that the table 110 has a plurality of tables and although the details will be described later, the processing unit 70 changes the table to refer to as appropriate according to the currently selected application.

When the main power supply of the mobile phone 1 is changed to ON state, the processing unit 70 starts the OS program first, and performs control so that a standby screen for communication is displayed on the display 21 by starting a standard application program under OS management. Thereafter, whenever there is an application to be started, the processing unit 70 performs control to start a new application program by ending or suspending the standard application program under OS management. By this processing, the processing unit 70 performs control to display on the display 21 a screen that is based on the application that is newly started instead of the standby screen. It should be noted that even if the application program that has been running is not the standard application program and is other application program, the processing unit 70 similarly starts a new application program by ending or suspending the application program that has been running. Then, the processing unit 70 performs control so as to change from the screen that is based on a prior application program to the screen that is based on a new application program.

The mobile phone 1 configured as such has a function to perform, in the state where the standby screen is displayed, the selection of the menu of the application by the rotation operation of the rotary dial unit 41 after the rotary dial unit 41 has been operated to be rotated and a predetermined application has been selected and started.

Here, the configuration for performing the function described above will be described on a function basis. As shown in FIG. 6, the mobile phone 1 includes an application execution unit 201, an operation unit 202 (operation means), and an operation control unit 203 (operation control means). It should be noted that the application execution unit 201 and the operation control unit 203 correspond to the processing unit 70.

In addition, the operation unit 202 has the operation key group 11 (input operation unit) and the rotary dial unit 41 (external operation unit). The operation control unit 203 controls various kinds of processing associated with the operation by the operation unit 202. When a predetermined application is running by the application execution unit 201, the operation control unit 203 assigns processing functions related to the predetermined application to a plurality of setting positions of the rotary dial unit 41. If the input by the operation key group 11 is detected when a predetermined application is running, the application execution unit 201 performs the processing function assigned to the predetermined setting position of the rotary dial unit 41.

By having such a configuration, in the mobile phone 1, it is possible to operate simply and intuitively the starting of an application or the like according to the preference of the user by having the rotary dial unit 41.

In addition, the mobile phone 1 includes a display control unit 204 which controls the display 21 (display unit). Preferably, the display control unit 204 displays information related to the processing function assigned to the rotary dial unit 41 on the display 21 when the predetermined application is being executed by the application execution unit 201. It should be noted that the display control unit 204 corresponds to the processing unit 70. In addition, upon displaying on the display 21 information (menu items) about the processing function assigned to each setting position of the rotary dial unit 41, it is desirable to make the processing function that is selected and executable easily recognizable, such as by displaying intensified the processing function corresponding to the setting position and adjusted to the selected position S.

By having such a configuration, it is possible to make the user recognize simply what direction to operate and where to stop the rotary dial unit 41 to execute the desired function in the mobile phone 1, thereby leading to improvement in usability.

In addition, in the mobile phone 1, it is desirable that the information related to the processing function assigned to the predetermined application is displayed on the external surface of the rotary dial unit 41.

By having such a configuration, it is possible to make the user recognize simply what direction to operate and where to stop the rotary dial unit 41 to execute the desired function in the mobile phone 1, thereby leading to improvement in usability.

In addition, in the mobile phone 1, it is desirable if the operation control unit 203 assigns the processing function for the image displayed on the display 21 when the predetermined application is running to each setting position of the rotary dial unit 41.

By having such a configuration, it is possible to make the user recognize simply what direction to operate and where to stop the rotary dial unit 41 to execute the desired function in the mobile phone 1, thereby leading to improvement in usability.

In addition, in the mobile phone 1, when a predetermined application is executed and information related to a certain other communication party is selected, it is desirable if the operation control unit 203 assigns the processing function related to the communications processing performed by the communication unit 60 to the certain other communication party to each setting position of the rotary dial unit 41.

By having such a configuration, it is possible to make the user recognize simply what direction to operate and where to stop the rotary dial unit 41 to execute the desired function in the mobile phone 1, thereby leading to improvement in usability.

In addition, in the mobile phone 1, when an application (editor) related to character inputting has been running, it is desirable if the operation control unit 203 assigns the processing function related to the character inputting to a setting position of the rotary dial unit 41.

By having such a configuration, in the mobile phone 1, by operating the rotary dial unit 41 in a predetermined direction when creating character strings with an editor, it is possible to switch Japanese “kava” cursive character inputting into number inputting, for example, and it is possible to create character strings simply and easily as compared with the conventional method (the method which presses the menu key by the operation key group 11 and selects number inputting in the menu displayed).

In addition, in the mobile phone 1, in the case where data that has not been saved yet is handled when a predetermined application has been started by the application execution unit 201, it is desirable if the operation control unit 203 assigns a processing function related to the save processing of the data to a setting position of the rotary dial unit 41.

By having such a configuration, save processing of data can be performed simply and easily in the mobile phone 1 by performing the rotation operation of the rotary dial unit 41.

In addition, in the mobile phone 1, in the case where a predetermined application has been started by the application execution unit 201 and data that has been saved is handled, it is desirable if the operation control unit 203 assigns a processing function related to utilization processing of the data to a setting position of the rotary dial unit 41.

By having such a configuration, utilization processing of data (for example, processing for transmitting to other terminals and the like) can be performed simply and easily in the mobile phone 1 by performing the rotation operation of the rotary dial unit 41.

In addition, in the mobile phone 1, when a predetermined application is executed by the application execution unit 201 and image data is handled, it is desirable if the operation control unit 203 assigns the processing function related to image editing processing of the image data to the setting position of the rotary dial unit 41.

By having such a configuration, the image editing processing of image data (for example, expansion and contraction of image data, and the like) can be performed simply and easily in the mobile phone 1 by performing the rotation operation of the rotary dial unit 41.

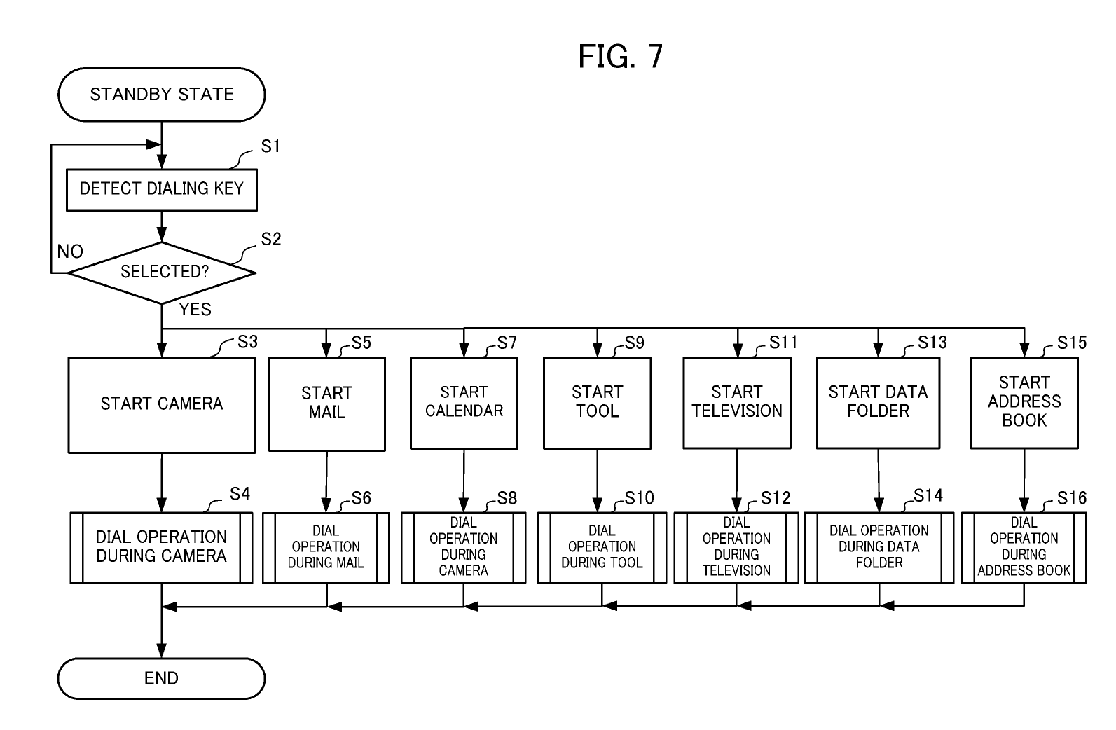

Here, the selection operation for various kinds of the applications and menus, which is performed using the rotary dial unit 41, will be described with reference to the flow chart shown in FIG. 7. It should be noted that in the standby state of communication (the state when the initial screen is displayed on the display 21), as shown in FIG. 5, a camera function of the imaging unit 17 is started by the rotary dial unit 41 being rotated 45 degrees to Direction a (315 degrees to Direction b) and a mail function is started by being rotated 90 degrees to Direction a (270 degrees to Direction b) from the non-operated situation (neutral (N)). Moreover, a calendar function is started by the rotary dial unit 41 being rotated 135 degrees to Direction a (225 degrees to Direction b) and a tool menu (the menu that performs various kinds of settings related to the sound output in the mobile phone 1 and the like) is started by being rotated 180 degrees to Direction a (180 degrees to Direction b) from the non-operated situation (N). Moreover, the television function is started by the rotary dial unit 41 being rotated 225 degrees to Direction a (135 degrees to Direction b), the data folder is started by being rotated 270 degrees to Direction a (90 degrees to Direction b), and an address book is started by being rotated 315 degrees to Direction a (45 degrees to Direction b) from the non-operated situation (N).

In step S1, the processing unit 70 detects the rotation operation of the rotary dial unit 41 in the standby state.

In step S2, from the detection result in the process in step S1, the processing unit 70 determines whether or not a certain application has been selected by the rotary dial unit 41 being rotated so that any one of various setting positions (other than neutral (N)) that are assigned to various applications is adjusted to the setting position S. When it is determined that an application has not been selected (No), the process returns to step S1, and when it is determined that an application has been selected (Yes), the process proceeds to steps S3 to S9 according to the selected application.

In step S2, when it is determined that the rotation angle of the rotary dial unit 41 is 45 degrees and the camera function has been selected, the process proceeds to step S3, the processing unit 70 starts the camera function, and the process proceeds to step S4.

In step S4, in the case where the rotation operation of the rotary dial unit 41 is performed when the camera function has been started by the process in step S3, the selection of various menus in the camera function is enabled in the processing unit 70. As such, when the camera function is selected at the standby screen, the processing unit 70 changes as appropriate the table in which functions and processes that are executed corresponding to the rotation angle of the rotary dial unit 41 are indicated according to the rotation operation of the rotary dial unit 41 such that the menu associated with the camera function can be selected.

In addition, in step S2, if it is determined that the rotation angle of the rotary dial unit 41 is 90 degrees and the mail function has been selected, the process to step S5, the processing unit 70 starts the mail function, and the process proceeds to step S6.

In step S6, in the case where the rotation operation of the rotary dial unit 41 is performed when the mail function has been started by the process in step S5, the selection of various menus in the mail function is enabled in the processing unit 70. As such, when a mail function is selected from the standby screen, the processing unit 70 changes as appropriate the table in which the functions and the processing that are executed corresponding to the rotation angle of the rotary dial unit 41 are indicated according to the rotation operation of the rotary dial unit 41 so that the menu associated with the mail function can be selected.

In addition, in step S2, if it is determined that the rotation angle of the rotary dial unit 41 is 135 degrees and the calendar function has been selected, the process proceeds to step S7, the processing unit 70 starts the calendar function, and the process proceeds to step S8.

In step S8, in the case where the rotation operation of the rotary dial unit 41 is performed when the calendar function has been started by the process in step S5, the selection of various menus in the calendar function is enabled in the processing unit 70. As such, when the calendar function is selected at the standby screen, the processing unit 70 changes as appropriate the table in which the functions and the processing that are executed corresponding to the rotation angle of the rotary dial unit 41 are indicated according to the rotation operation of the rotary dial unit 41 so that the menu associated with the calendar function can be selected.

In addition, in step S2, if it is determined that the rotation angle of the rotary dial unit 41 is 180 degrees and the tool function has been selected, the process proceeds to step S9, the processing unit 70 starts the tool function and the process proceeds to step S10.

In step S10, in the case where the rotation operation of the rotary dial unit 41 is performed when the tool function has been started by the process in step S5, the selection of various menus in the tool function is enabled in the processing unit 70. As such, when the tool function is selected at the standby screen, the processing unit 70 changes as appropriate the table in which the functions and the processing that are executed corresponding to the rotation angle of the rotary dial unit 41 are indicated according to the rotation operation of the rotary dial unit 41 so that the menu associated with the tool function can be selected.

In addition, in step S2, if it is determined that the rotation angle of the rotary dial unit 41 is 225 degrees and the television function has been selected, the process proceeds to step S11, and the processing unit 70 starts the television function and the process proceeds to step S12.

In step S12, in the case where the rotation operation of the rotary dial unit 41 is performed when the television function has been started by the process in step S5, the selection of various menus in the television function is enabled in the processing unit 70. As such, when the television function is selected at the standby screen, the processing unit 70 changes as appropriately the table in which the functions and the processing that are executed corresponding to the rotation angle of the rotary dial unit 41 are indicated according to the rotation operation of the rotary dial unit 41 so that the menu associated with the television function can be selected.

In addition, in step S2, if it is determined that the rotation angle of the rotary dial unit 41 is 270 degrees and the data folder function has been selected, the process proceeds to step S13, the processing unit 70 starts the data folder function, and the process proceeds to step S14.

In step S14, in the case where the rotation operation of the rotary dial unit 41 is performed when the data folder function has been started by the process in step S5, the selection of various menus in the data folder function is enabled in the processing unit 70. As such, when the data folder function is selected at the standby screen, the processing unit 70 changes as appropriately the table in which the functions and the processing that are executed corresponding to the rotation angle of the rotary dial unit 41 are indicated according to the rotation operation of the rotary dial unit 41 so that the menu associated with the data folder function can be selected.

In addition, in step S2, if it is determined that the rotation angle of the rotary dial unit 41 is 315 degrees and the address book function has been selected, the process proceeds to step S15, the processing unit 70 starts the address book function, and the process proceeds to step S16.

In step S16, in the case where the rotation operation of the rotary dial unit 41 is performed when the address book function is started by the process in step S5, the selection of various menus in the address book function is enabled in the processing unit 70. As such, when the address book function is selected at the standby screen, the processing unit 70 changes as appropriately the table in which the functions and the processing that are executed corresponding to the rotation angle of the rotary dial unit 41 are indicated according to the rotation operation of the rotary dial unit 41 so that the menu associated with the address book function can be selected.

### Detailed Operation of the Process in Step S4

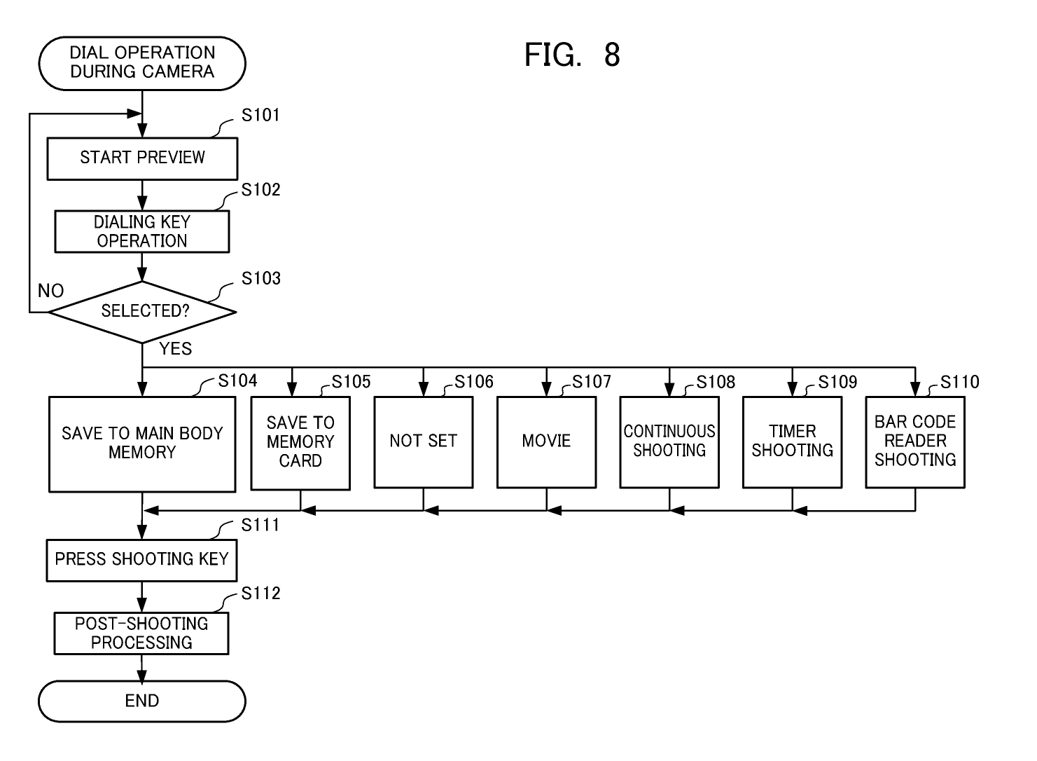

Here, the detailed operation of the processing unit 70 in the case where the rotation operation of the rotary dial unit 41 is performed when the camera has been started and the application related to the camera function is running (has been started) according to the process in steps S3 and S4 described above will be described using FIG. 8 (step S101 to step S112).

In step S101, the processing unit 70 starts the preview.

In step S102, the processing unit 70 detects the rotation operation of the rotary dial unit 41.

In step S103, the processing unit 70 determines from the detection result in the process in step S102 whether or not the menu has been selected by any one of the setting positions of the rotary dial unit 41 being adjusted to the selection position S. When it is determined that the menu has not been selected, the process returns to step S102, and when it is determined that the menu has been selected (Yes), the process proceeds to steps S104 to S110 according to the selected menu.

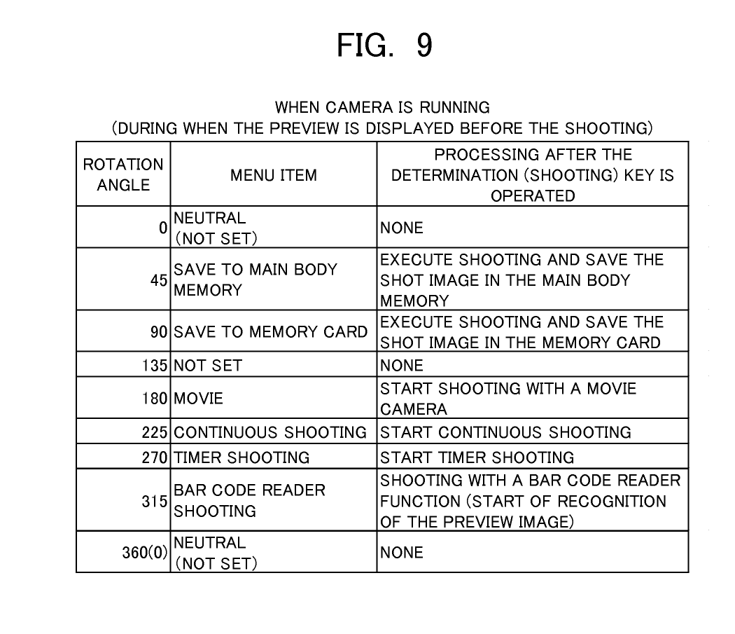

Here, in the case where the rotation operation of the rotary dial unit 41 is performed when the camera function is running and the preview before the shooting is displayed, the processing unit 70 performs operations according to the rotation angle by referring to the table shown in FIG. 9.

Specifically, in steps S102 and S103, if it is detected that the rotary dial unit 41 has been rotated 45 degrees to a predetermined direction from the non-operated situation (0 degree or 360 degrees), the process proceeds to step S104, and regarding that the menu of “save to main body memory” has been selected, the processing unit 70 sets to have a processing content that saves the shot image (shot data) into the main body memory of the mobile phone 1 as the processing content of the post-shooting processing in step S112 described later.

In addition, if it is detected that the rotary dial unit 41 has been rotated 90 degrees to a predetermined direction, the process proceeds to step S105, and regarding that the menu of “save to memory card” has been selected, the processing unit 70 sets to have a processing content that saves the shot image (shot data) into the detachable and attachable memory card as the processing content of the post-shooting processing in step S112 described later.

In addition, if it is detected that the rotary dial unit 41 has been rotated 135 degrees to a predetermined direction, the process proceeds to step S106, and regarding that the menu of “not yet set” has been selected, the processing unit 70 sets to have a processing content that do not perform the operation of the post-shooting processing in step S112 described later.

In addition, if it is detected that the rotary dial unit 41 has been rotated 180 degrees to a predetermined direction, the process proceeds to step S107, and regarding that the menu of “movie” has been selected, the processing unit 70 sets to have a processing content that starts movie shooting as the processing content of the post-shooting processing in step S112 described later.

In addition, if it is detected that the rotary dial unit 41 has been rotated 225 degrees to a predetermined direction, the process proceeds to step S108, and regarding that the menu of “continuous shooting” has been selected, the processing unit 70 sets to have a processing content that starts continuous shooting as the processing content of the post-shooting processing in step S112 described later.

In addition, if it is detected that the rotary dial unit 41 has been rotated 270 degrees to a predetermined direction, the process proceeds to step S109, and regarding that the menu of “timer shooting” has been selected, the processing unit 70 sets to have a processing content that starts timer shooting as the processing content of the post-shooting processing in step S112 described later.

In addition, if it is detected that the rotary dial unit 41 has been rotated 315 degrees to a predetermined direction, the process proceeds to step S110, and regarding that the menu of “bar code reader shooting” has been selected, the processing unit 70 sets to have a processing content that starts bar code recognition as the processing content of the post-shooting processing in step S112 described later.

As such, when a press of a shooting key (determination key) is detected in step S111 after the content of the post-shooting processing (processing in step S112) is set according to the menu selected by the rotation operation of the rotary dial unit 41 in step S104 to step S110, the process proceeds to step S112 and the post-shooting processing set in step S104 to step S110 according to the selected menu is executed.

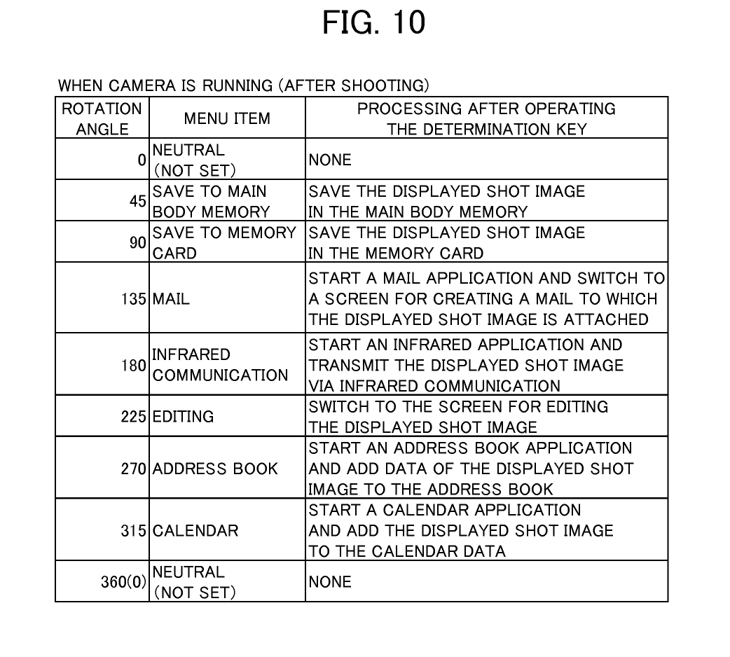

Next, the content of the table that is referred to in the case where the rotary dial unit 41 is operated when the camera function is running and the image obtained by the shooting is displayed will be described using FIG. 10.

In the case where the menu that is assigned to each setting that corresponds to the rotation angle is selected by the rotary dial unit 41 being performed the rotation operation when the camera function is running and the photographic subject has been shot, the processing unit 70 performs an operation (menu function) according to the rotation angle by referring to the table shown in FIG. 10. Specifically, when the rotary dial unit 41 is rotated 45 degrees to a predetermined direction from the non-operated situation (0 degree or 360 degrees) and the determination operation is performed, the processing unit 70 saves the shot data of the displayed shot image in the main body memory. In addition, when the rotary dial unit 41 is rotated 90 degrees to a predetermined direction and the determination operation is performed, the processing unit 70 saves the shot data in the memory card that can be detachable from and attachable to the main body of the mobile phone 1.

In addition, when the rotary dial unit 41 is rotated 135 degrees to a predetermined direction and the determination operation is performed, the processing unit 70 starts the mail application and displays the screen for creating a mail to which the displayed shot data is attached.

In addition, when the rotary dial unit 41 is rotated 180 degrees to a predetermined direction and the determination operation is performed, the processing unit 70 enables to transmit the displayed shot data to external communication apparatus via infrared communication by starting an infrared application.

In addition, when the rotary dial unit 41 is rotated 225 degrees to a predetermined direction and the determination operation is performed, the processing unit 70 displays the editing screen for editing (for example, expansion and contraction of the shot data, and the like) the displayed shot data.

In addition, when the rotary dial unit 41 is rotated 270 degrees to a predetermined direction and the determination operation is performed, the processing unit 70 starts the address book application and registers additionally the displayed shot data (for example, face image) into the user data selected among the user data registered in the address book.

In addition, when the rotary dial unit 41 is rotated 315 degrees to a predetermined direction and the determination operation is performed, the processing unit 70 starts the calendar application and registers additionally the displayed shot data (for example, face image) to the calendar data selected among the calendar data.

It should be noted that the processing unit 70 does not operate when the rotary dial unit 41 is rotated 360 degrees to a predetermined direction and the determination operation is performed.

### Detailed Operation of the Process in Step S13

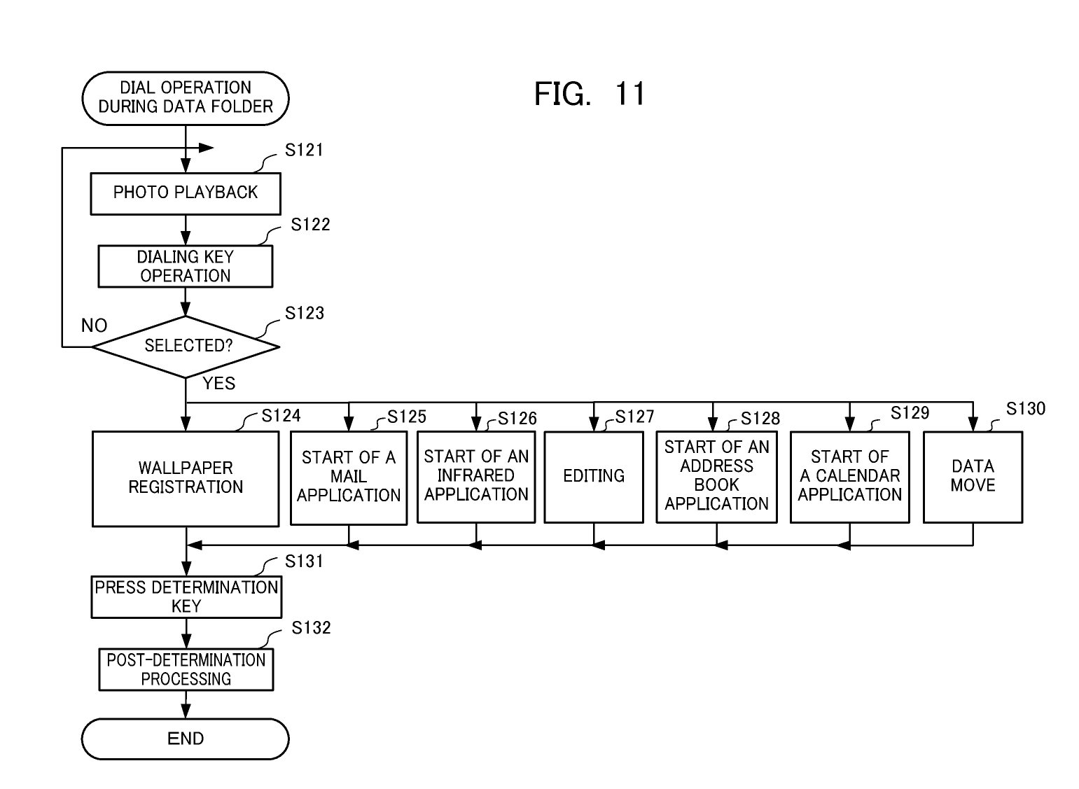

Here, the detailed operation of the processing unit 70 in the case where the rotation operation of the rotary dial unit 41 is performed after the application related to the data folder function has been started in the process in step S13 described above will be described using FIG. 11 (step S121 to step S132).

In step S121, the processing unit 70 executes a photograph playback function and performs the thumbnail display of the data in the data folder.

In step S122, the processing unit 70 detects the rotation operation of the rotary dial unit 41.

In step S123, the processing unit 70 determines from the detection result in the process in step S122 whether or not any one of the menus that are associated with the setting positions is selected by one of the setting positions of the rotary dial unit 41 being adjusted to the selected position S. When it is determined that the menu has not been selected, the process returns to step S122, and when it is determined that the menu has been selected (Yes), the process proceeds to steps S124 to S130 according to the selected menu. Thereafter, the determination key is pressed (step S131) and post-determination processing is performed (step S132).

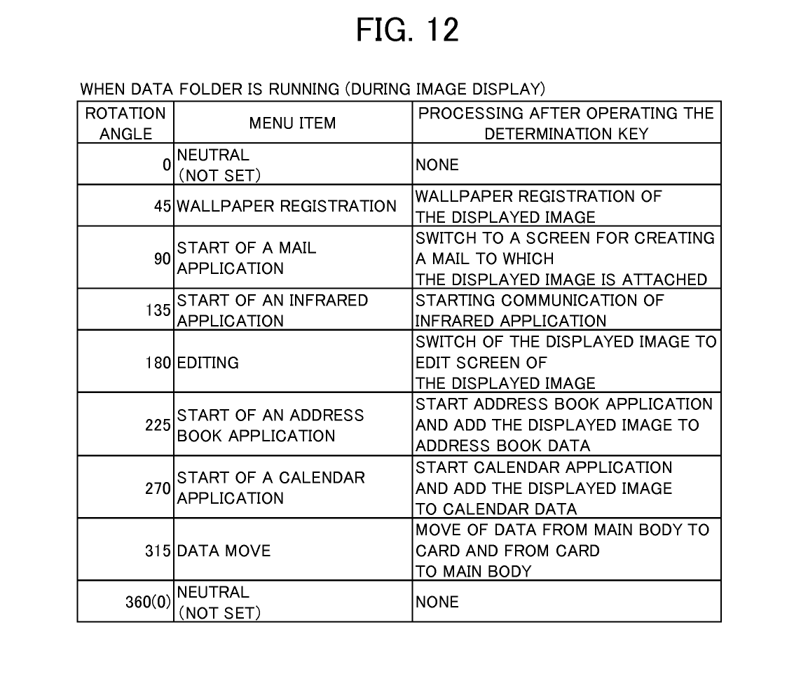

Here, in the case where rotation operation of the rotary dial unit 41 is performed while the data folder function is running, the processing unit 70 performs an operation according to the rotation angle by referring to the table shown in FIG. 12.

Specifically, in step S122 and step S123, if it is detected that the rotary dial unit 41 is rotated 45 degrees to a predetermined direction from the non-operated situation (0 degree or 360 degrees), the process proceeds to step S124, and regarding that the menu of “wallpaper registration” has been selected, the processing unit 70 sets to have a processing content that registers the displayed image as wallpaper (background of the standby screen) as the processing content of the post-determination processing displayed in step S132 described later.

In addition, if it is detected that the rotary dial unit 41 has been rotated 90 degrees to a predetermined direction, the process proceeds to step S125, and regarding that the menu of “start mail application” has been selected, the processing unit 70 sets to have a processing content that attaches the displayed image onto the screen for creating a mail as the processing content of the post-determination processing in step S132 described later.

In addition, if it is detected that the rotary dial unit 41 is rotated 135 degrees to a predetermined direction, the process proceeds to step S126, and regarding that the menu of “start infrared application” has been selected, the processing unit 70 sets to have a processing content that transmits the displayed image to outside via infrared communication by starting the infrared application as the processing content of the post-determination processing in step S132 described later.

In addition, if it is detected that the rotary dial unit 41 has been rotated 180 degrees to a predetermined direction, the process proceeds to step S127, and regarding that the menu of “edit” has been selected, the processing unit 70 sets to have a processing content that changes to the editing screen for editing (for example, expansion and contraction of the shot data, and the like) the displayed image as the processing content of the post-determination processing in step S132 described later.

In addition, if it is detected that the rotary dial unit 41 has been rotated 225 degrees to a predetermined direction, the process proceeds to step S128, and regarding that the menu of “start address book application” has been selected, the processing unit 70 sets to have a processing content that changes to the setting screen for adding the displayed image into the address book as the processing content of the post-determination processing in step S132 described later.

In addition, if it is detected that the rotary dial unit 41 has been rotated 270 degrees to a predetermined direction, the process proceeds to step S129, and regarding that the menu of “start calendar application” has been selected, the processing unit 70 sets to have a processing content that changes to the setting screen for saving the displayed image to the calendar data as the processing content of the post-determination processing in step S132 described later.

In addition, if it is detected that the rotary dial unit 41 has been rotated 315 degrees to a predetermined direction, the process proceeds to step S130, and regarding that the menu of “move data” has been selected, the processing unit 70 sets to have a processing content that moves the displayed image to another location, such as a memory detachable from and attachable to the data folder, when the post-determination processing in step S132 described later is executed.

### Mail Function

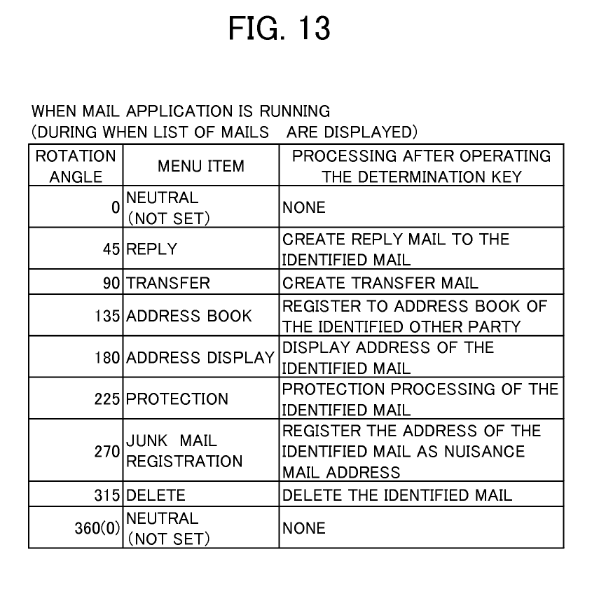

Next, the content of the table that is referred to when the rotary dial unit 41 is operated after the application related to the mail function has been started in the process in step S5 described above will be described using FIG. 13.

In the case where the rotation operation of the rotary dial unit 41 is performed while the mail function is running, the processing unit 70 sets the processing content after the determination key has been depressed according to the rotation angle by referring to the table shown in FIG. 13. When it is detected that the rotary dial unit 41 is rotated 45 degrees to a predetermined direction from the non-operated situation (0 degree or 360 degrees), the processing unit 70 sets a processing content that creates a reply mail to the mail identified by the cursor selection or the like from the list of mails listed on the display 21 as the processing content after the determination operation.

In addition, when it is detected that the rotary dial unit 41 is rotated 90 degrees to a predetermined direction, the processing unit 70 sets a processing content that creates a forwarding mail of the mail identified by the cursor selection or the like from the list of mails listed on the display as the processing content after the determination operation.

In addition, when it is detected that the rotary dial unit 41 is rotated 135 degrees to a predetermined direction, the processing unit 70 sets a processing content that registers the other party of the mail identified by the cursor selection or the like into the address book from the list of mails listed on the display 21 as the processing content after the determination operation.

In addition, when it is detected that the rotary dial unit 41 is rotated 180 degrees to a predetermined direction, the processing unit 70 sets a processing content that displays the address of the mail identified by the cursor selection or the like from the list of mails listed on the display 21 as the processing content after the determination operation.

In addition, when it is detected that the rotary dial unit 41 is rotated 225 degrees to a predetermined direction, the processing unit 70 sets a processing content that performs protection processing (processing for protection to disable deletion) of the mail identified by the cursor selection or the like from the list of mails listed on the display 21 as the processing content after the determination operation.

In addition, when it is detected that the rotary dial unit 41 is rotated 270 degrees to a predetermined direction, the processing unit 70 sets a processing content that registers the address of the mail identified by the cursor selection or the like from the list of mails listed on the display 21 as a nuisance mail address as the processing content after the determination operation.

In addition, when it is detected that the rotary dial unit 41 is rotated 315 degrees to a predetermined direction, the processing unit 70 sets a processing content that deletes the mail identified by the cursor selection or the like from the list of mails listed on the display 21 as the processing content after the determination operation.

### Calendar Function

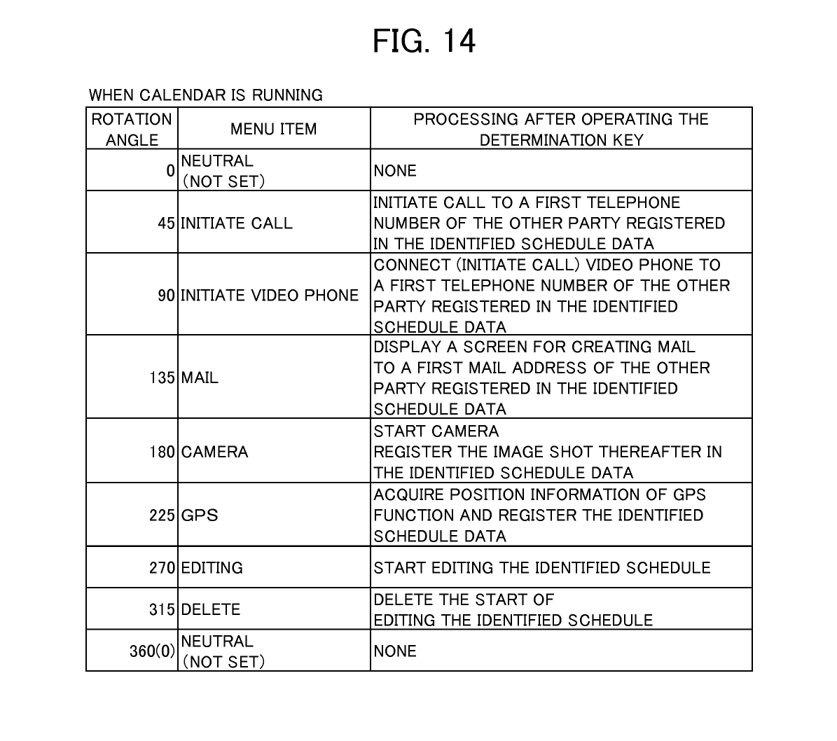

Next, the content of the table that is referred to when the rotary dial unit 41 is operated after the application related to the calendar function is started in the process in step S7 described above will be described using FIG. 14.

When the rotation operation of the rotary dial unit 41 is performed while the calendar function is running, the processing unit 70 sets the processing content after the press of the determination key according to the rotation angle by referring to the table shown in FIG. 14. Specifically, when it is detected that the rotary dial unit 41 is rotated 45 degrees to a predetermined direction from the non-operated situation (0 degree or 360 degrees), the processing unit 70 sets a processing content that performs call origination to the first telephone number of the other party registered into the schedule data identified by the cursor selection or the like from the list of schedules listed on the display 21 as the processing content after the determination operation.

In addition, when it is detected that the rotary dial unit 41 is rotated 90 degrees to a predetermined direction, the processing unit 70 sets a processing content that performs video phone connection (call origination) to the first telephone number of the other party registered into the schedule data identified by the cursor selection or the like from the list of schedules listed on the display 21 as the processing content after the determination operation.

In addition, when it is detected that the rotary dial unit 41 is rotated 135 degrees to a predetermined direction, the processing unit 70 sets a processing content that displays the screen for creating a mail to the identified first mail address of the other party registered into the schedule data identified by the cursor selection or the like from the list of schedules listed on the display 21 as the processing content after the determination operation.

In addition, when it is detected that the rotary dial unit 41 is rotated 180 degrees to a predetermined direction, the processing unit 70 sets the processing content that starts the camera function as the processing content after the determination operation in order to register the shot image into the schedule data identified by the cursor selection or the like from the list of schedules listed on the display 21.

In addition, when it is detected that the rotary dial unit 41 is rotated 225 degrees to a predetermined direction, the processing unit 70 generates the position information with a GPS (global positioning system) function to which the processing content is set in order to register the position information into the schedule data identified by the cursor selection or the like from the list of schedules listed on the display 21 as the processing content after the determination operation,

In addition, when it is detected that the rotary dial unit 41 is rotated 270 degrees to a predetermined direction, the processing unit 70 sets a processing content that displays the screen for editing (for example, addition and change of a schedule, and the like) the schedule data by the cursor selection or the like from the list of schedules listed on the display 21 as the processing content after the determination operation.

In addition, when it is detected that the rotary dial unit 41 is rotated 315 degrees to a predetermined direction, the processing unit 70 sets a processing content that deletes the schedule data identified by the cursor selection or the like from the list of schedules listed on the display 21 as the processing content after the determination operation.

### Address Book Function

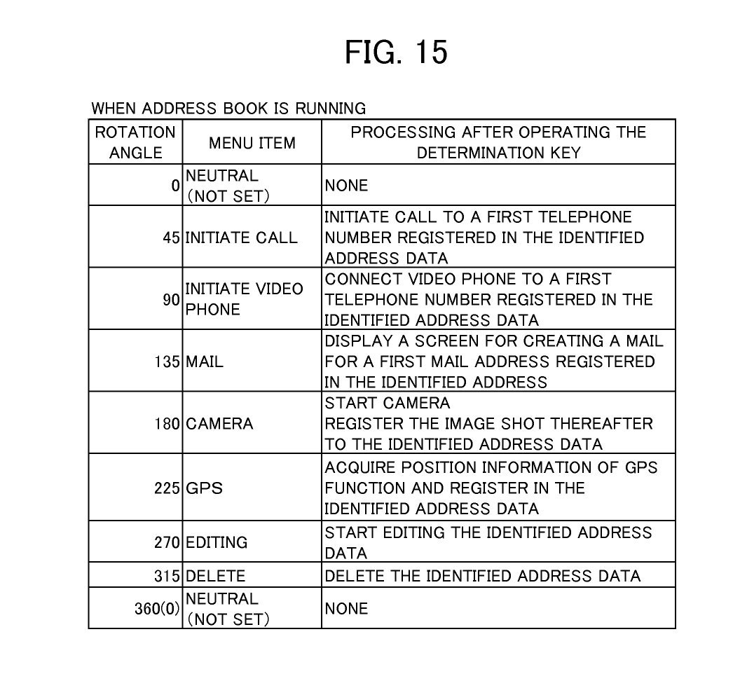

Next, the table content selected when the rotary dial unit 41 is operated after the application related to the address book function is started in the process in step S15 described above will be described using FIG. 15.

When the rotation operation of the rotary dial unit 41 is performed while the address book function is running, the processing unit 70 refers to the table shown in FIG. 15, and sets the processing content after the press of the determination key according to the rotation angle. Specifically, when it is detected that the rotary dial unit 41 is rotated 45 degrees to a predetermined direction from the non-operated situation (0 degree or 360 degrees), the processing unit 70 sets a processing content that performs call origination to the first telephone number registered into the address data identified by the cursor selection or the like from the list of addresses listed on the display 21 as the processing content after the determination operation.

In addition, by the rotary dial unit 41 being rotated 90 degrees to a predetermined direction, the processing unit 70 sets a processing content that performs video phone connection (call origination) to the first telephone number registered into the address data identified by the cursor selection or the like from the list of addresses listed on the display 21 as the processing content after the determination operation.

In addition, by the rotary dial unit 41 being rotated 135 degrees to a predetermined direction, the processing unit 70 sets a processing content that displays the screen for creating a mail to the first mail address registered into the address data identified by the cursor selection or the like from the list of addresses listed on the display 21 as the processing content after the determination operation.

In addition, by the rotary dial unit 41 being rotated 180 degrees to a predetermined direction, the processing unit 70 sets a processing content that starts the camera function in order to register the shot data into the address data identified by the cursor selection or the like from the list of addresses listed on the display 21 as the processing content after the determination operation.

In addition, by the rotary dial unit 41 being rotated 225 degrees to a predetermined direction, the processing unit 70 sets a processing content that generates position information with a GPS (global positioning system) function in order to register the position information into the address data identified by the cursor selection or the like from the list of addresses listed on the display 21 as the processing content after the determination operation.

In addition, by the rotary dial unit 41 being rotated 270 degrees to a predetermined direction, the processing unit 70 sets a processing content that displays the screen for editing (for example, correction of the name registered in the address, and the like) the address data identified by the cursor selection or the like from the list of addresses listed on the display 21 as the processing content after the determination operation.

In addition, by the rotary dial unit 41 being rotated 315 degrees to a predetermined direction, the processing unit 70 sets a processing content that deletes the address data identified by the cursor selection or the like from the list of addresses listed on the display 21 as the processing content after the determination operation.

As such, the present invention has the following advantageous effects.

1. In the present invention, since the next transition destination (the processing content after the determination operation) can be determined by determining the input state of the rotary dial unit 41, it is possible to transit directly to the desired state to be transited regardless of the tree configuration by the operation of the determination key.

2. In the present invention, since the state of the rotary dial unit 41 (the processing content after the determination operation) is displayed by not only the screen but by the screen and the key, its appearance can be easily seen and it is possible to make the user understand easily.

3. In the present invention, since “the desired function to use” can be selected according to the application that has been started with the rotary dial unit 41, the multi-functionalized mobile phone 1 can be used simply.

4. In the present invention, by way of selecting “data folder” by the rotary dial unit 41 at the time of shooting (when camera is running), it is possible to save the image obtained by the shooting in the data folder by pressing down the determination key or the like.

5. In the present invention, if “mail” has been selected by the rotary dial unit 41 while the image is viewed (displayed), it is possible to change to the screen for creating a mail to which the displayed image is attached by the press of the determination key or the like.

6. In the present invention, by selecting “camera (or infrared)” by the rotary dial unit 41 and depressing the determination key or the like, it is possible to start the camera (or infrared) function regardless of the present state.

7. In the present invention, since the state of input by the rotary dial unit 41 is taken into consideration, it is possible to change to an optimal state with a predetermined operating method and the operation is easy. That is, by the same operation such as the press of the determination key, it is possible to operate promptly and easily any processing corresponding to the application that has been started according to the state of the rotary dial unit 41.

8. In the present invention, since it is changed directly to the target state, the operation speed improves.

It should be noted that, in the present embodiment, although an example is shown that identifies the processing (menu) corresponding to the application that is to be started or the application that has been started based on the rotation amount of the rotary dial unit 41, the present invention is not limited to this. That is, it is suitable as long as it can determine what rotation state it is, and for example, it may have a configuration that detects only the final rotation position. Moreover, if the processing (menus) corresponding to the application or the application that has been started is associated with each of the final rotation positions and stored in the table 110, by referring to this, it may be configured to start the application according to the identified position, or to set the processing to correspond to the application that is started.

Furthermore, by measuring the time from when the rotation was started until the final rotation position is reached, it may be configured to distinguish whether the rotation is a fast rotation or a slow rotation, and according to this, to change the application or the like that is to be started. In this case, by associating the application or the like to be started with each rotation period and storing in the table 110, and performing table reference of the period from when the rotation is started until when the rotation is suspended, for example, it is possible to enable the start of an application or the like differently by the difference between the rotation speeds even if the rotation is performed to the same position

### Other Embodiments

In the embodiment described above, one embodiment using the rotary dial unit 41 has been shown and the present invention is not limited to this. For example, when using a text editor (a software program for creating, editing and saving a text file), the mobile phone 1 may assign an edit assisting function to the rotary dial unit 41.

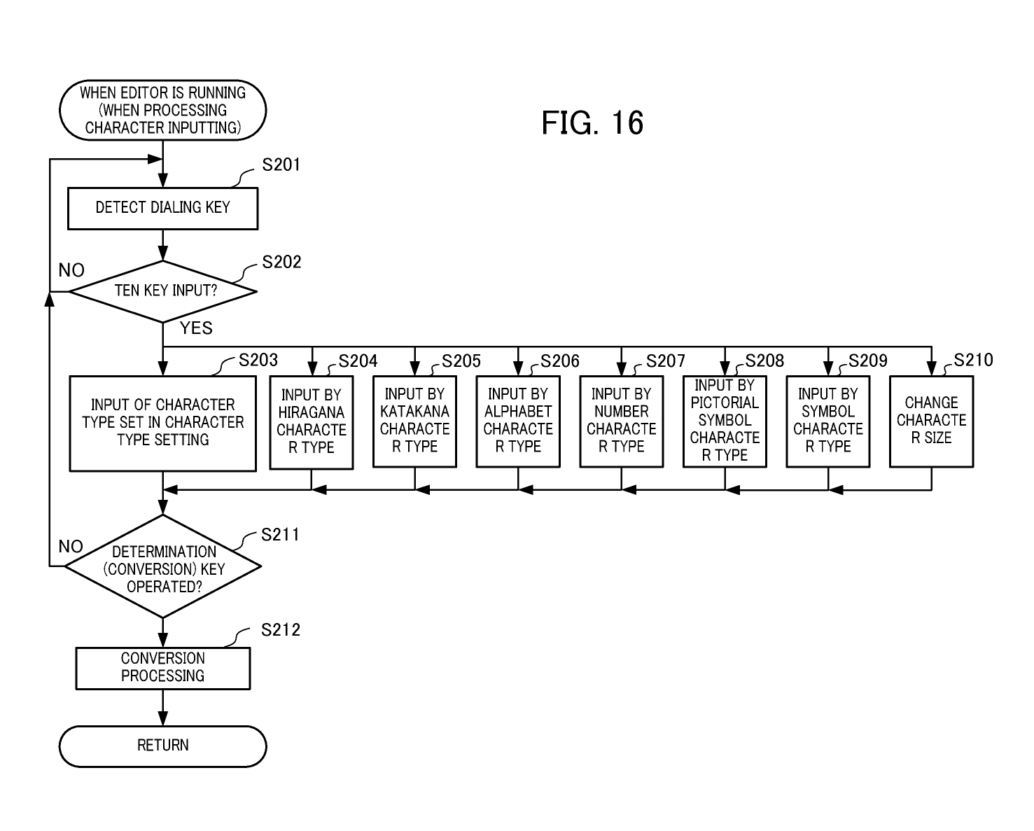

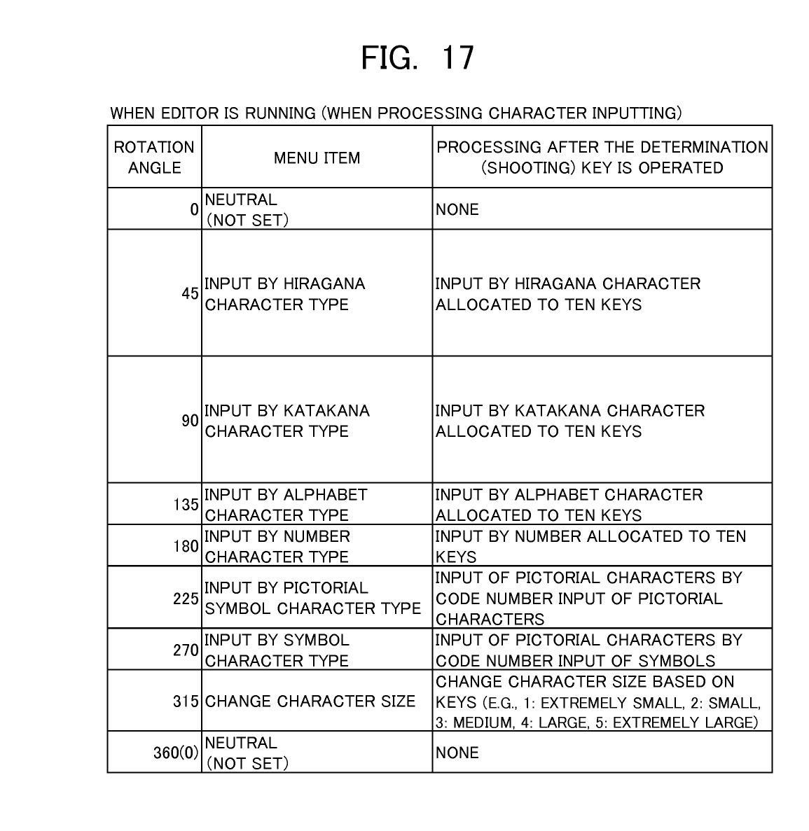

Here, a method for editing in a text editor using the rotary dial unit 41 will be described using the flow chart shown in FIG. 16 and the content of the reference table shown in FIG. 17. It should be noted that, hereafter, it is assumed that the text editor has been started by a predetermined operation.

In step S201, the processing unit 70 detects the rotation operation of the rotary dial unit 41.

In step S202, the processing unit 70 detects whether or not there has been an input by ten-keys (input operation buttons 14). When there has been an input by the ten-key that serves as the determination key for determining the character to be inputted (Yes), according to the detection result in the process in step S201, the process proceeds to step S203 to step S210, and when there has been no input by the ten-keys, the process returns to step S201 (No).

Here, when a text editor is running and there is an input by the ten-keys, the processing unit 70 detects the setting position adjusted to the selected position S among the setting positions of the rotary dial unit 41, and based on the rotation state of the rotary dial unit 41 (selected setting position), performs an operation according to the rotation angle by referring to the table shown in FIG. 17.

Specifically, if there has been an input from the ten-keys, the processing unit 70 refers to the table shown in FIG. 17, and when the rotary dial unit 41 is non-operated or one round operation (0 degree or 360 degrees), inputs the character type that is set by the character type setting which is set separately (step S203). In addition, by the up-and-down keys of the determination operation button 15 being pressed, the processing unit 70 performs the conversion processing of a character that is tentatively inputted, and by the center key of the determination operation button 15 being pressed (step S211), the tentatively inputted character is fixed (step S212).

In addition, when there is an input from the ten-keys in the state where the rotary dial unit 41 is rotated 45 degrees to a predetermined direction, the processing unit 70 inputs the character assigned to the ten-key in hiragana (step S204). In addition, by the up-and-down keys of the determination operation button 15 being pressed, the processing unit 70 performs the conversion processing of a character that is tentatively inputted, and by the center key of the determination operation button 15 being pressed (step S211), the character that is tentatively inputted is fixed (step S212).

In addition, when there is an input from the ten-keys in the state where the rotary dial unit 41 is rotated 90 degrees to a predetermined direction, the processing unit 70 inputs the character assigned to the ten-key in katakana (step S205). In addition, by the up-and-down keys of the determination operation button 15 being pressed, the processing unit 70 performs the conversion processing of a character that is tentatively inputted, and by the center key of the determination operation button 15 being pressed (step S211), the character that is tentatively inputted is fixed (step S212).

In addition, when there is an input from the ten-keys in the state where the rotary dial unit 41 is rotated 135 degrees to a predetermined direction, the processing unit 70 inputs with the alphabetic character assigned to the ten-key (step S206). In addition, by the up-and-down keys of the determination operation button 15 being pressed, the processing unit 70 performs the conversion processing of a character that is tentatively inputted, and by the center key of the determination operation button 15 being pressed (step S211), the character that is tentatively inputted is fixed (step S212).

In addition, when there is an input from the ten-keys in the state where the rotary dial unit 41 is rotated 180 degrees to a predetermined direction, the processing unit 70 inputs with the number assigned to the ten-key (step S207). In addition, by the up-and-down keys of the determination operation button 15 being pressed, the processing unit 70 performs the conversion processing of a character that is tentatively inputted, and by the center key of the determination operation button 15 being pressed (step S211), the character that is tentatively inputted is fixed (S212).

In addition, when there is an input from the ten-keys in the state where the rotary dial unit 41 is rotated 225 degrees to a predetermined direction, the processing unit 70 inputs the pictorial symbol corresponding to the code number inputted by the press of the ten-keys (step S208). In addition, by the up-and-down keys of the determination operation button 15 being pressed, the processing unit 70 performs the conversion processing of a character that is tentatively inputted, and by the center key of the determination operation button 15 being pressed (step S211), the character that is tentatively inputted is fixed (step S212).

In addition, when there is an input from the ten-keys in the state where the rotary dial unit 41 is rotated 270 degrees to a predetermined direction, the processing unit 70 inputs with the symbol assigned to the ten-key (step S209). In addition, by the up-and-down keys of the determination operation button 15 being pressed, the processing unit 70 performs the conversion processing of a character that is tentatively inputted, and by the center key of the determination operation button 15 being pressed (step S211), the character that is tentatively inputted is fixed (step S212).

In addition, when there is an input from the ten-keys in the state where the rotary dial unit 41 is rotated 315 degrees to a predetermined direction, the processing unit 70 performs temporary setting of character size according to the character size assigned to the inputted ten-key, and the character(s) that has (have) been inputted until then and displayed on the screen of the display 21 is changed to the size of the temporarily set character size to be displayed (step S210). In addition, by the center key of the determination operation button 15 being pressed (step S211), the processing unit 70 fixes the temporarily set character size (step S212). For example, when the key to which “1” of the ten-key is printed is pressed, the processing unit 70 changes the character size to extremely small size, when the key to which “2” of the ten-key is printed is pressed, it changes the character size to small size, when the key to which “3” of the ten-key is printed is pressed, it changes the character size to medium size, when the key to which “4” of the ten-key is printed is pressed, it changes the character size to large size, and when the key to which “5” of the ten-key is printed is pressed, it changes the character size to extremely large size.

As such, in the present invention, the selection of an input character type or the like is performed according to the rotation state of the rotary dial unit 41, and any character(s) is (are) inputted by the input from the ten-keys (determination key). Moreover, in the present invention, it is possible to perform various changes, such as in the character type at the time of character inputting, character size, and the like, easily by the rotary dial unit 41, to input desired character(s) easily and smoothly, and improve the character input operability.

### Second Embodiment

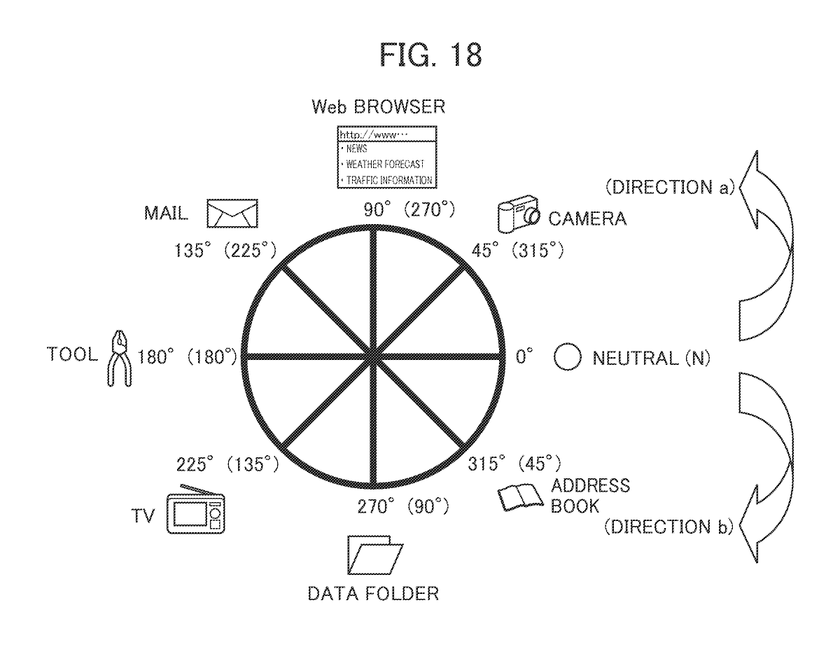

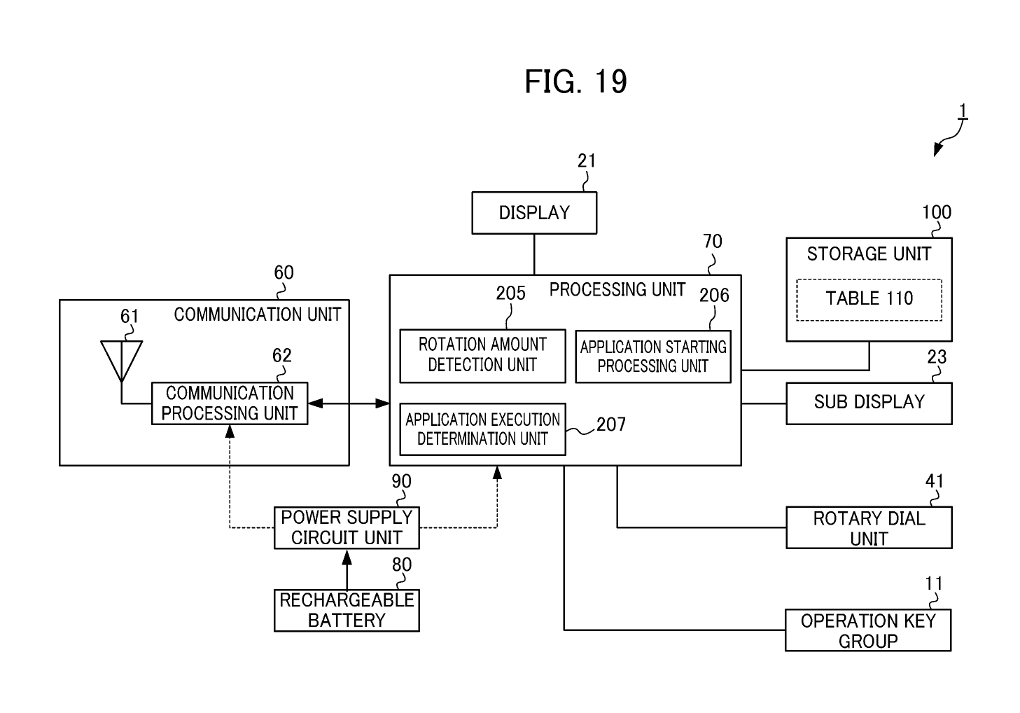

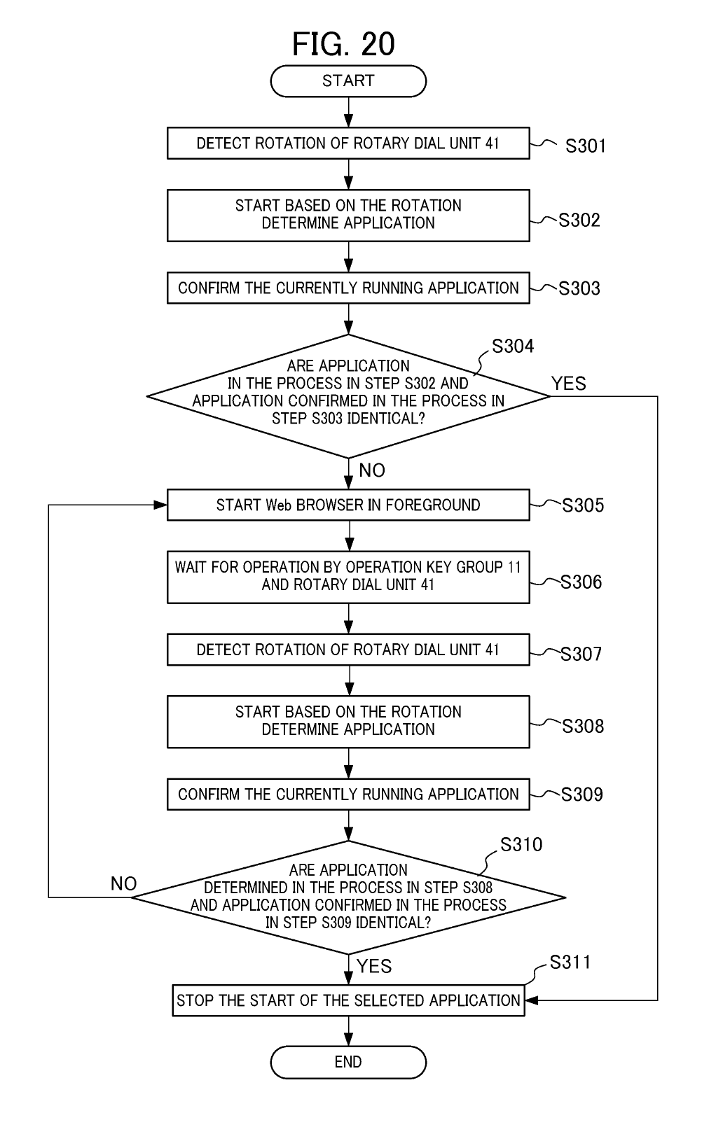

Hereafter, the second embodiment of the present invention will be described. In the second embodiment, points of difference from the first embodiment described above will be described mainly, and points in common are assigned the same reference label and the descriptions thereof are omitted. For the points not described in particular, the description of the first embodiment is applied as appropriate. FIG. 18 is a drawing for illustrating the function of the rotary dial unit 41 according to the second embodiment. FIG. 19 is a functional block diagram showing the function of the mobile phone 1 according to the second embodiment. FIG. 20 is a flow chart for illustrating the specific operation (operation for avoiding conflicts among applications) of the processing unit 70 of the mobile phone 1 according to the second embodiment.

In addition, the rotary dial unit 41 can perform the menu selection which executes various kinds of functions according to the operation of the physical rotary dial. For example, as shown in FIG. 18, by the rotary dial unit 41 being rotated 45 degrees to Direction a (315 degrees to Direction b) from the non-manipulated situation (neutral (N)) with the rotation operation of the user, the camera function of the imaging unit 17 is started, and by being rotated 90 degrees to Direction a (270 degrees to Direction b), the web browser is started. Moreover, by the rotary dial unit 41 being rotated 135 degrees to Direction a (225 degrees to Direction b) from the non-operated situation (N), the mail application is started, and by being rotated 180 degrees to Direction a (180 degrees to Direction b), the tool menu (menu that performs various kinds of setting related to the sound output in the mobile phone 1 or the like) is started. Moreover, by the rotary dial unit 41 being rotated 225 degrees to Direction a (135 degrees to Direction b) from the non-operated situation (N), the television function is started, by being rotated 270 degrees to Direction a (90 degrees to Direction b), the data folder is started, and by being rotated 315 degrees to Direction a (45 degrees to Direction b), the address book is started.

It should be noted that the menu assigned according to the rotation angle of the rotary dial unit 41 described above is an example, and is not limited to this, and for example, the present invention may have a configuration that is enabled to register the menu that the user himself/herself uses frequently, and may have a configuration that is enabled to browse a web page of a web address by registering the desired web address and selecting the web address with the rotary dial unit 41 to start the web browser. In addition, the number of the menus is also not limited to the above-described number (seven).

In addition, under a certain condition, by operating the rotary dial unit 41 directly, the user can directly start various functions assigned to the rotary dial unit 41, and it is possible to start the desired application simply without the need to use the main menu as conventionally.

In addition, FIG. 19 is a functional block diagram showing the function of the mobile phone 1. As shown in FIG. 19, the mobile phone 1 includes a display 21 which is not exposed outside in a closed state, which serves as the display unit; and a sub display 23 which is exposed outside even in a closed state. Furthermore, it includes an operation key group 11 for the operation of the user; a rotary dial unit 41 for the operation of the user; a communication unit 60 for communicating with external terminals; a processing unit 70 which performs predetermined processing; a rechargeable battery 80 that has a predetermined capacity; a power supply circuit unit 90 which converts the power supply voltage supplied from the rechargeable battery 80 to a predetermined voltage and supplies the converted voltage to the communication unit 60, the processing unit 70, or the like; and a storage unit 100 having a table 101.

The communication unit 60 has a main antenna 61 for communicating with external devices with a predetermined utilizing frequency band; and a communication processing unit 62 which performs signal processing such as modulation processing and demodulation processing.

The main antenna 61 communicates with external devices (base stations) with a predetermined utilizing frequency band (for example, 800 MHz). It should be noted that, in the present embodiment, although the predetermined utilizing frequency band is 800 MHz, other frequency bands may be used. In addition, the main antenna 61 may have a configuration of a so-called dual band supported type which can support a second utilizing frequency band (for example, 2 GHz), and further a configuration of a so-called multiple band supported type that can support a third utilizing frequency band or more.

The communication processing unit 62 performs the demodulation processing of the signal received by the main antenna 61, supplies the signal that underwent the processing to the processing unit 70, and meanwhile performs the modulation processing of the signal supplied from the processing unit 70 and transmits to external devices (base stations) via the main antenna 61.

The power supply circuit unit 90 transforms the power supply voltage supplied from the rechargeable battery 80 to a predetermined voltage value, and supplies the power supply voltage that underwent the transformation to the communication unit 60, the processing unit 70 or the like.

Many programs and parameters executed at the processing unit 70, various tables, or the like are stored in the storage unit 100. Specifically, the storage unit 100 stores many application programs that are started, ended, suspended, and so on at the processing unit 70, parameters used in these plurality of the applications, and OS (Operating System) programs for operating the plurality of application programs, and correspondence relationships (see FIG. 18) between the rotation amount detected by the rotation amount detection unit 205 described later for details and the plurality of the applications as well, and furthermore, a table 110 showing whether or not the application can also be started in a closed state. It should be noted that the application programs for each application that the mobile phone 1 has such as a standard application, an application for image playback, a camera application, and a mail application are included in the plurality of application programs.

The processing unit 70 performs the starting processing corresponding to various functions according to the rotation amount supplied from the rotary dial unit 41. Here, the configuration and the operation of the processing unit 70 will be described. The processing unit 70 controls to detect the rotation amount of the rotary dial unit 41, start the predetermined application according to the detected rotation amount, and display the display screen corresponding to the started predetermined application on the display 21. It should be noted that, although the amount of change in the angle of the rotary dial unit 41 is detected as the rotation in this embodiment, the present invention is not limited to this, and is suitable as long as it is capable of detecting the change according to the rotation of the rotary dial unit 41, and for example, may detect the change in resistivity or the like as the rotation amount. Alternatively, the rotation position (or the rotation angle) of the rotary dial unit 41 may be detected to perform the control according to the detected rotation position.

In addition, the processing unit 70 identifies the application according to the rotation amount by referring to the table 110 of the correspondence relationship of the applications in the storage unit 100 whenever the rotation of the rotary dial unit 41 takes place. It should be noted that the table 110 has a plurality of tables, and as will be described later in detail, the processing unit 70 changes the table to refer to as appropriate according to the currently selected application.

If the main power supply of the mobile phone 1 is brought to ON state, the processing unit 70 controls to starts the OS program first, and to display a standby screen for communication on the display 21 by starting the standard application program under OS management. Thereafter, the processing unit 70 controls to start a new application program by ending or suspending the standard application program under OS management whenever there is an application to be started. By this processing, the processing unit 70 controls to display on the display 21 the screen that is based on the newly started application instead of the standby screen. It should be noted that the processing unit 70 starts a new application program by ending or suspending the application program that has been running also even in the case where the application program that has been running was not the standard application program but was an application program other than that. Moreover, the processing unit 70 controls to change the screen that is based on a prior application program to the screen that is based on a new application program.

In the mobile phone 1 configured as such, when an application that is the same as the currently running application is selected by operating the rotary dial unit 41, there is a function to maintain the currently running application without performing the starting processing of the application that has been selected with the operation of the rotary dial unit 41.

Here, the specific configuration and operation of the processing unit 70 for performing the function will be described in detail. As shown in FIG. 19, the processing unit 70 includes a rotation amount detection unit 205, an application starting processing unit 206, and an application execution determination unit 207.

The rotation amount detection unit 205 detects the rotation of the rotary dial unit 41. Here, in the present embodiment, although the rotation amount detection unit 205 is configured to detect the amount of change in the angle of the rotary dial unit 41, the present invention is not limited to this configuration in particular, and is suitable as long as it can detect the change that corresponds to the rotation of the rotary dial unit 41. For example, the rotation amount detection unit 205 may have a configuration that detects the rotation amount of the rotary dial unit 41 as the change in resistivity and detects the rotation amount of the rotary dial unit 41 from the detected value. Alternatively, the rotation amount detection unit 205 may have a configuration that detects the rotation position (or rotation angle) of the rotary dial unit 41 and detects the rotation amount of the rotary dial unit 41 from the detected rotation position.

The application starting processing unit 206 determines one application among a plurality of the applications based on the rotation detected by the rotation amount detection unit 205 and starts the application. The application execution determination unit 207 determines whether or not the application determined in the application starting processing unit 206 is running.

In addition, when it is determined in the application execution determination unit 207 that the application determined in the application starting processing unit 206 is running, the application starting processing unit 206 suspends starting of the application.

Therefore, upon starting an application according to the rotation operation at the rotary dial unit 41, the mobile phone 1 confirms the currently running application, and when the application is the same as the currently running application, stops the start of the application selected with the rotation operation of the rotary dial unit 41. As such, the mobile phone 1 can improve usability by avoiding conflicting processing of the applications.

In addition, when it is determined in the application execution determination unit 207 that the application determined in the application starting processing unit 206 is running in the background while a plurality of the applications are running, the application starting processing unit 206 executes the processing as follows. The application starting processing unit 206 executes the processing to stop starting of the application, to switch to execute the application running in the background to run in the foreground, and to switch the application running in the foreground to run in the background.

By having such a configuration, when an application that is identical to an application running in the background is selected by the rotary dial unit 41, since the mobile phone 1 switches the active and inactive states of the running applications so that the application running in the background is not ended and that application runs in the foreground, it is possible to improve the usability by avoiding the conflicting processing among the applications.

Here, the detailed operation of the processing unit 70 will be described with reference to the flow chart shown in FIG. 20. It should be noted that the description is presumed of the case where the mobile phone 1 starts a web browser according to the operation of the rotary dial unit 41 from the state where only the standby application is running, and then, selecting an e-mail address (starting of mail application is associated) displayed in the web browser, and thereafter, selecting a mail application by the rotary dial unit 41 when the mail application is running.

In step S301, the rotation amount detection unit 205 detects the rotation of the rotary dial unit 41. It should be noted that the standby screen is displayed on the display 21 in the process in step S301.

In step S302, the application starting processing unit 206 determines the application to start based on the rotation detected in the process in step S301. In this embodiment, the application starting processing unit 206 determines that the web browser has been selected. It should be noted that the standby screen is displayed on the display 21 in the process in step S302.

In step S303, the application starting processing unit 206 confirms the currently running application by the application execution determination unit 207. In this embodiment, the application starting processing unit 206 confirms that only the standby application is running.

In step S304, the application execution determination unit 207 determines whether or not the application determined in the process in step S302 and the application confirmed in the process in step S303 are the same. When it is determined that they are the same (Yes), the process proceeds to step S311, and when it is determined that they are not the same, the process proceeds to step S305 (No). In this embodiment, since the currently running application is a standby application and the selected application is a web browser, the application execution determination unit 207 determines that they are not the same.

In step S305, the application starting processing unit 206 performs starting processing of the application. In this embodiment, the application starting processing unit 206 starts the web browser in the foreground. It should be noted that the web browser is displayed on the display 21 in the process in step S305.

In step S306, the processing unit 70 awaits an operation by the operation key group 11 and the rotary dial unit 41. In a strict sense, the rotation amount detection unit 205 awaits the operation by the rotary dial unit 41. In addition, in this embodiment, the e-mail address (the start of the mail application is associated) that is displayed on the web browser is selected by the operation key group 11. The processing unit 70 starts the mail application in the foreground. It should be noted that the processing unit 70 may perform processing for ending the web browser, or may keep the web browser running in the background. In addition, in this embodiment, the rotary dial unit 41 is subjected to a rotation operation from the present position (position which starts the web browser) to the position for starting the mail application by the operation of the user in the state where the mail application has been started.

In step S307, the rotation amount detection unit 205 detects the rotation of the rotary dial unit 41.

In step S308, the application starting processing unit 206 determines the application to start based on the rotation detected in the process in step S307. In this embodiment, the application starting processing unit 206 determines that the mail application was selected.

In step S309, the application starting processing unit 206 confirms the currently running application by the application execution determination unit 207. In this embodiment, the application starting processing unit 206 confirms that the mail application is running.

In step S310, the application execution determination unit 207 determines whether or not the application determined in the process in step S308 and the application confirmed in the process in step S309 are the same. When it is determined that they are the same (Yes), the process proceeds to step S311, and when it is determined that they are not the same, the process returns to step S305 (No). In this embodiment, the application execution determination unit 207 determines that both the currently running application and the selected application are mail applications and they are the same.

In step S311, the application starting processing unit 206 stops the start of the selected application in order to avoid conflicted processing. Therefore, the currently running mail application is maintained as it is.

As such, according to the rotation operation of the rotary dial unit 41, upon starting the application, the mobile phone 1 confirms the currently running application, and when it is the same as the currently running application, since the start of the application that is selected by the rotation operation of the rotary dial unit 41 is stopped, it is possible to improve usability by avoiding conflicting processing of the applications.

In addition, as another embodiment, the mobile phone 1 may have a configuration that stops the start of the selected application only in the case where the state of the currently running application is in a particular state (for example, a particular state such as a state under communication and a state during a creation of a mail in the case of a mail application).

### Third Embodiment

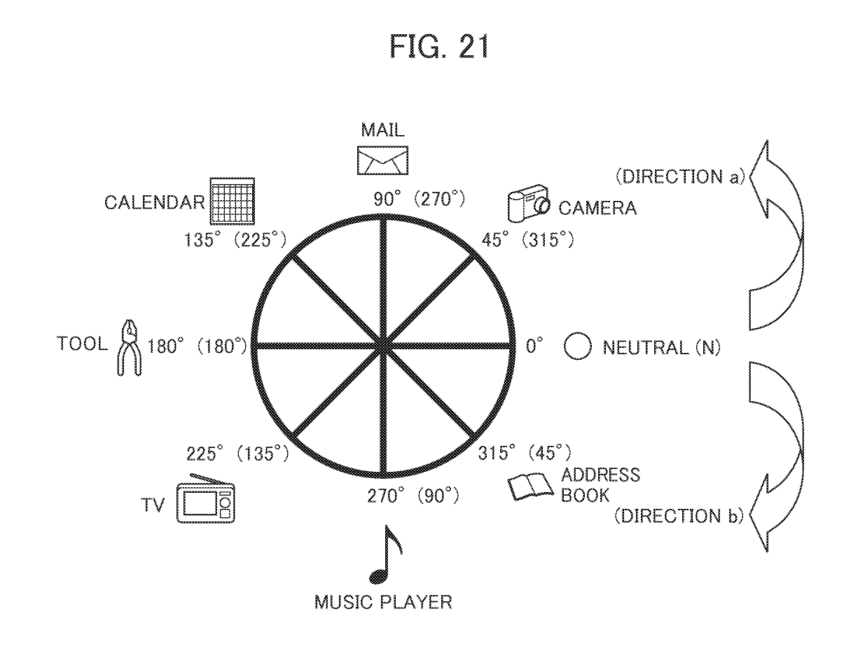

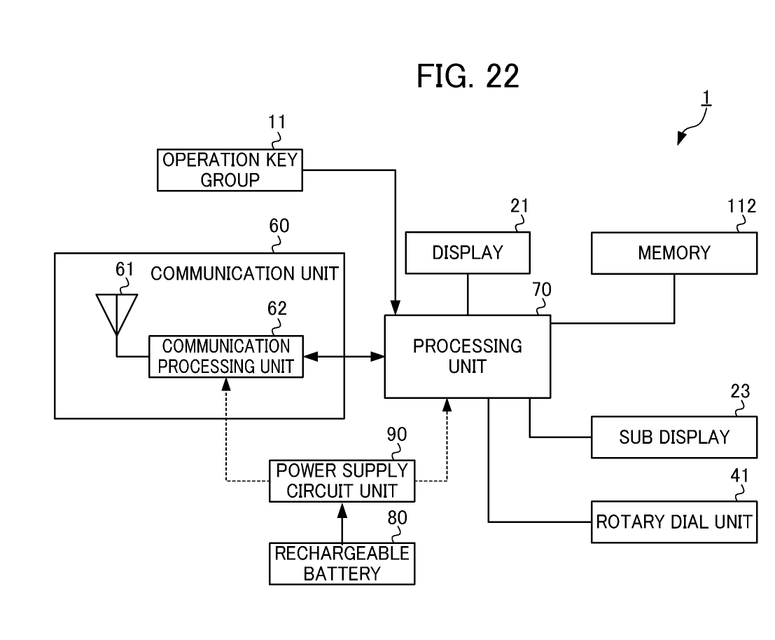

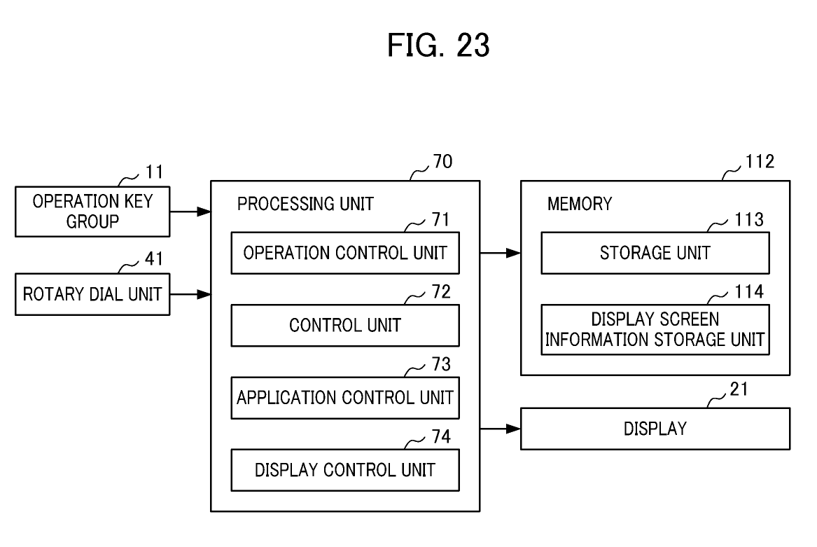

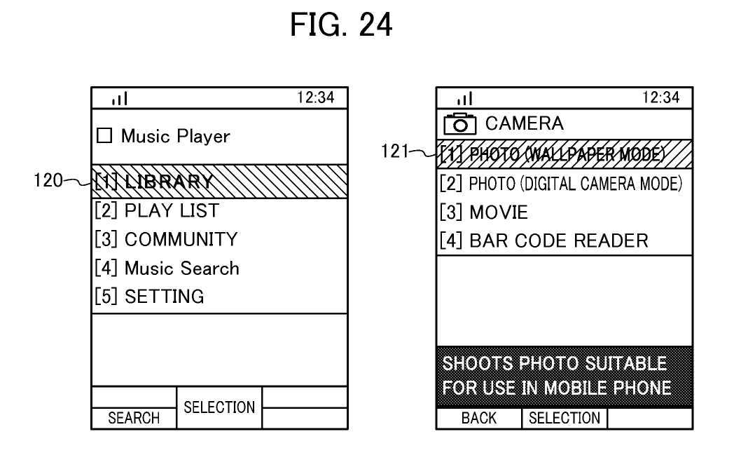

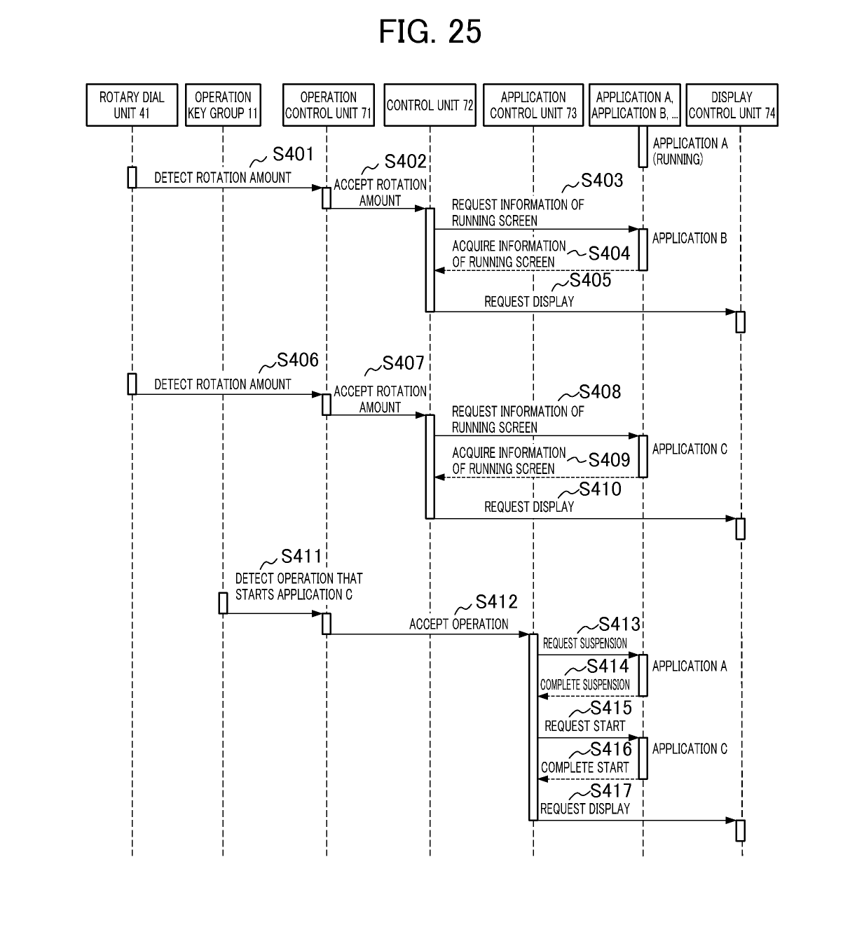

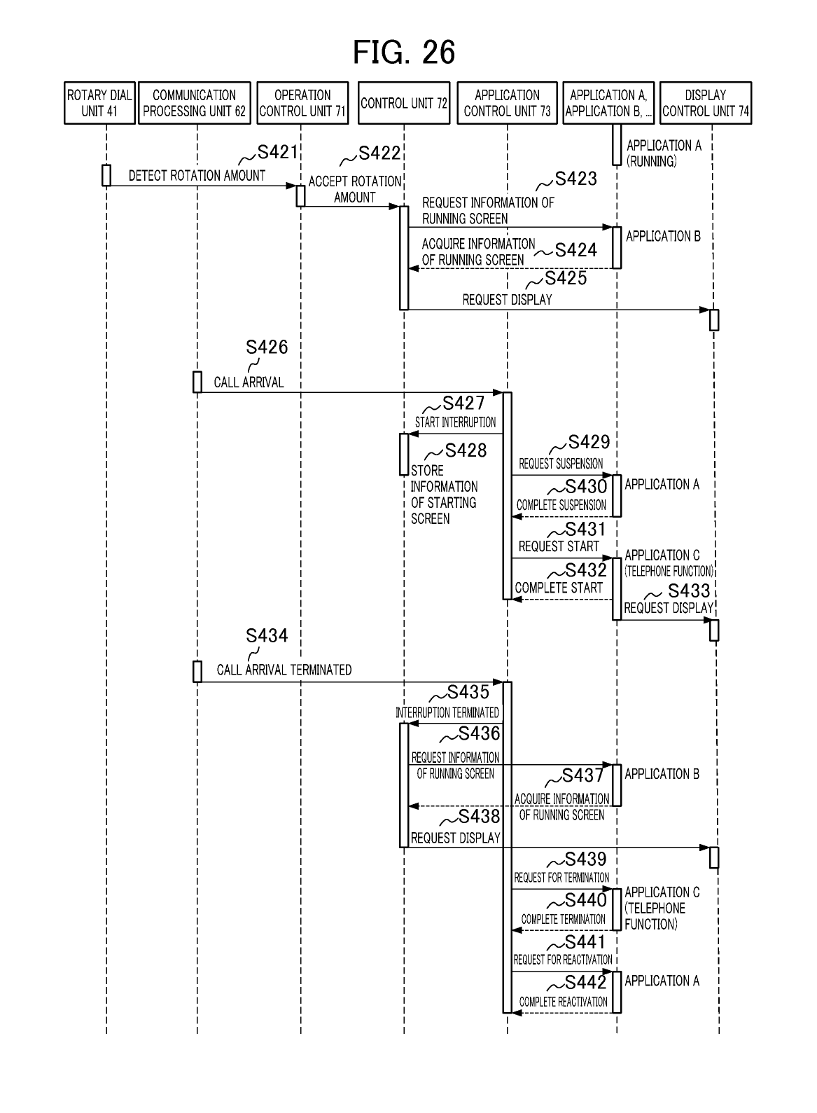

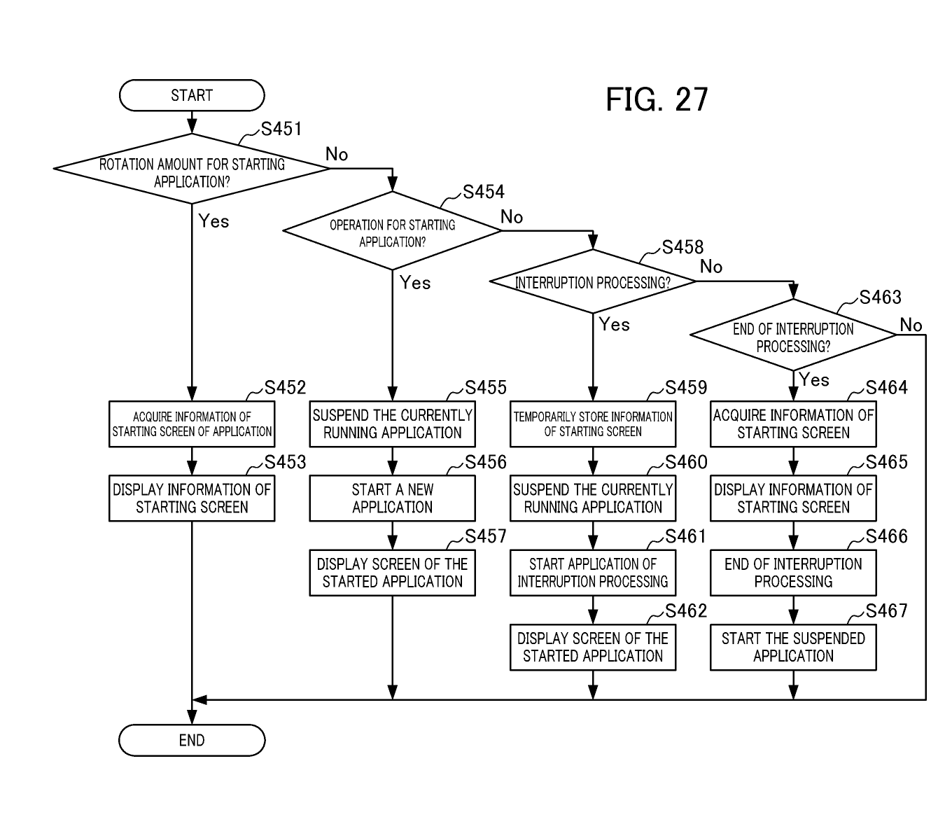

Hereafter, the third embodiment of the present invention will be described. In the third embodiment, points of difference points from the first embodiment described above will be described mainly, and points in common are assigned the same reference label and the descriptions thereof are omitted. For the points not described in particular, the description of the first embodiment is applied as appropriate. FIG. 21 is a drawing for illustrating the function of the rotary dial unit according to the third embodiment. FIG. 22 is a functional block diagram showing the function of the mobile phone 1 according to the third embodiment. FIG. 23 is a functional block diagram showing the function of the processing unit 70 included in the mobile phone 1 according to the third embodiment. FIG. 24 is a drawing showing an example of information of the starting screen of the application stored in the storage unit 113 according to the third embodiment. FIG. 25 is a sequence diagram showing the flow of processing by the mobile phone 1 according to the third embodiment. FIG. 26 is a sequence diagram showing the flow of processing by the mobile phone 1 according to the third embodiment. FIG. 27 is a flow chart showing the flow of processing of the mobile phone 1 according to the third embodiment.

In addition, the rotary dial unit 41 can perform the menu selection that executes various kinds of functions according to the operation of the physical rotary dial. For example, as shown in FIG. 21, by the rotary dial unit 41 being rotated 45 degrees to Direction a (315 degrees to Direction b) from the non-manipulated situation (neutral (N)) by the rotation operation of the user, the camera function of the imaging unit 17 is started and by being rotated 90 degrees to Direction a (270 degrees to Direction b), the mail function is started. Moreover, by the rotary dial unit 41 being rotated 135 degrees to Direction a (225 degrees to Direction b) from the non-operated situation (N), the calendar function is started and by being rotated 180 degrees to Direction a (180 degrees to Direction b), the tool menu (the menu that performs various kinds of setting related to the sound output in the mobile phone 1 or the like) is started. Moreover, by the rotary dial unit 41 being rotated 225 degrees to Direction a (135 degrees to Direction b) from the non-operated situation (N), the television function is started, and by being rotated 270 degrees to Direction a (90 degrees to Direction b), the music player function is started, and by being rotated 315 degrees to Direction a (45 degrees to Direction b), the address book is started.

It should be noted that the menu assigned according to the rotation angle of the rotary dial unit 41 described above is an example, and the present invention is not limited to this, and for example, may have a configuration that can register the menu that the user himself/herself frequently uses. In addition, the menu may have a configuration that can browse a web page of a web address by registering the desired web address and selecting the web address by the rotary dial unit 41 to start the web browser. In addition, the number of the menus is also not limited to the number (seven) described above.

In addition, under a certain condition, by directly operating the rotary dial unit 41, various functions assigned to the rotary dial unit 41 can be started directly, and thus it is not necessary to use the main menu as conventionally, and it is possible to start the desired application simply.

In addition, FIG. 22 is a functional block diagram showing the function of the mobile phone 1. As shown in FIG. 22, the mobile phone 1 includes an operation key group 11, a display 21 which is not exposed outside in a closed state, which serves as the display unit, and a sub display 23 exposed outside even in a closed state. Furthermore, it includes a rotary dial unit 41 that is rotated by the operation of the user, a communication unit 60 for communicating with an external terminal, a processing unit 70 which performs predetermined processing, a rechargeable battery 80 having a predetermined capacity, and a power supply circuit unit 90 which converts the power supply voltage supplied from the rechargeable battery 80 and supplies the voltage that underwent the conversion to the communication unit 60, the processing unit 70, or the like, and the memory 112.

The communication unit 60 includes a main antenna 61 for communicating with external devices with a predetermined utilizing frequency band, and a communication processing unit 62 which performs signal processing such as modulation processing or demodulation processing.

The main antenna 61 communicates with external devices (base stations) with a predetermined utilizing frequency band (for example, 800 MHz). It should be noted that, in the present embodiment, although the predetermined utilizing frequency band is 800 MHz, other frequency bands may be used. In addition, the main antenna 61 may have a configuration of so-called dual band supported type that can support a second utilizing frequency band (for example, 2 GHz) other than the predetermined utilizing frequency band, and may have a configuration of so-called multiple band supported type that can support a third utilizing frequency band.

The communication processing unit 62 performs demodulation processing of the signal received by the main antenna 61, and supplies the signal that underwent the processing to the processing unit 70, and meanwhile performs the modulation processing of the signal supplied from the processing unit 70, and transmits to external devices (base stations) via the main antenna 61.

The power supply circuit unit 90 transforms the power supply voltage supplied from the rechargeable battery 80 to a predetermined voltage value, and supplies the power supply voltage that underwent the transformation to the communication unit 60, the processing unit 70 or the like.

The memory 112 includes working memories such as VRAM (Video RAM), and many programs and parameters that are executed in the processing unit 70 and various tables, and the like. Specifically, the memory 112 stores many application programs that are started, ended, suspended, and so on, in the processing unit 70, parameters used in these plurality of applications, an OS (Operating System) program for operating the plurality of application programs, and correspondence relationships (see FIG. 21) between the rotation amount detected by the operation control unit 71 and the plurality of the applications as well. It should be noted that application programs for each application that the mobile phone 1 has such as a standard application, a music player, a camera, a mail, or the like is included in the plurality of application programs.

The processing unit 70 performs the starting processing corresponding to various functions according to the rotation amount supplied from the rotary dial unit 41. It should be noted that although the operation control unit 71 described later detects the amount of change in the angle of the rotary dial unit 41 as the rotation amount in the present embodiment, the present invention is not limited to this and is suitable as long as it can detect the change according to the rotation amount of the rotary dial unit 41. For example, the processing unit 70 may detect the change in resistivity, or the like as the rotation amount.

FIG. 23 is a functional block diagram that further describes in detail about the function and operation of the operation key group 11, the rotary dial unit 41, the processing unit 70, and the memory 112. As shown in FIG. 23, the processing unit 70 includes an operation control unit (an operation detection unit, a rotation amount detection unit) 71, a control unit 72, an application control unit 73, and a display control unit 74.

The memory 112 stores the information to be displayed on the display 21. In addition, the memory 112 includes a storage unit 113 and a display screen information storage unit 114.

The storage unit 113 stores the information of the display screen for each application that is to be displayed on the display 21. In addition, it is desirable if the information of the display screen of the application stored in the storage unit 113 is the information of the starting screen that is displayed when the application is started.

The display screen information storage unit 114 is constituted by VRAM or the like, and stores temporarily the information of the display screen displayed on the display 21. In addition, it is desirable if the information of the display screen of the application temporarily stored in the display screen information storage unit 114 is the information of the starting screen that is displayed when the application is started.

The operation control unit 71 detects the operation of the operation key group 11 by the user, and the rotation amount in the rotary dial unit 41. Moreover, the operation control unit 71 notifies the operation of the detected operation key group 11 or the rotation amount of the rotary dial unit 41 to the control unit 72 and the application control unit 73.

When the rotation amount (first rotation amount) for selecting the application is detected by the operation control unit 71, the control unit 72 acquires the information of the display screen of the application by referring to the storage unit 113. Moreover, the control unit 72 controls to display on the display 21 the information of the acquired display screen. That is, the control unit 72 transmits the information of the display screen to the display control unit 74 in order to display on the display 21 the information of the acquired display screen.

As such, according to the mobile phone 1 of the present embodiment, when an operation for selecting the application is detected by the operation control unit 71, it is controlled to acquire the information of the display screen of the application and to display on the display 21 the information of the acquired display screen by referring to the storage unit 113.

Accordingly, when the user only rotates the rotary dial unit 41 and does not perform the operation for operating or starting the application, it is possible to display the information of the display screen of the application virtually on the display 21 instead of actually operating or starting the application.

In addition, in the case of executing the start or the operation of this application, it becomes necessary for the processing for suspending the application that has been already started and for starting or operating a new application according to the rotation amount of the rotary dial unit 41. However, according to the mobile phone 1 of the present embodiment, the information of the display screen of the new application is only displayed virtually and the start or the operation of the new application is not performed. Therefore, it is possible to reduce the load of processing by the processing unit 70 for suspending and reactivating the application that has already been started and for starting and operating a new application.

FIG. 24 is a drawing showing an example of the information of the starting screen of the application, which is stored in the storage unit 113. As shown in FIG. 24, the starting screen 120 is an application having a music playback function, and the starting screen 121 is an application having the function to operate the imaging unit 17.

Moreover, in the starting screens thereof displayed on the display 21, the user can start the operation of the application from the starting screen by the operation of the operation key group 11. For example, in the starting screen 120, by performing the operation of selecting “[1] library” and running it, the application that actually has a music playback function is started from the information of the starting screen displayed virtually. Then, as for the screen displayed upon the start of the application, the screen when the “[1] library” is run in the application, and not the starting screen 120, is displayed on the display 21.

Similarly, in the starting screen 120, in the starting screen 121, by performing an operation to select and run “[1] photograph (wallpaper mode)”, the application having the function to actually operate the imaging unit 17 from the information of the starting screen displayed virtually is started. Moreover, as for the screen upon the start of the application, the screen when “[1] photo (wallpaper mode)” is run in the application, and not the starting screen 121, is displayed on the display 21.

In addition, instead of the information of the display screen of the application, according to the start of the operation of a new application, the control unit 72 displays information of the display screen of the new application on the display 21, and stores the information of the display screen of the application in the display screen information storage unit 114.

As such, according to the mobile phone 1 of the present embodiment, instead of the information of the display screen of the application displayed virtually according to the start of the operation of the new application, the information of the display screen of the new application is displayed on the display 21, and the information of the display screen of the application that is displayed virtually is stored in the display screen information storage unit 114 as well.

Thereby, when the new application starts the operation by a call arrival or the like, the information of the display screen of this new application can be displayed on the display 21. Furthermore, by making the display screen information storage unit 114 store temporarily the information of the display screen that is displayed virtually, the information of the stored display screen can be displayed again.

The application control unit 73 controls the execution of the application such as the start, suspending, reactivating, and so on, of a plurality of the applications stored in the memory 112. For example, the application control unit 73 starts the predetermined application according to the rotation amount detected by the operation control unit 71.

Then, when the operation (first operation, third operation) for operating the application by the operation control unit 71 is detected after the rotation amount is detected by the operation control unit 71, the application control unit 73 controls to operate this application by removing the information of the display screen from the application.

As such, according to the mobile phone 1 of the present embodiment, when the operation for executing the application corresponding to the information of this display screen is detected while displaying the information of the display screen on the display 21 virtually, except for the information of the display screen that was displayed virtually, the application corresponding to the information of this display screen is started.

At this time, the screen displayed on the display 21 displays a display screen when operating the application by the operation of the operation key group 11 not in the information of the display screen that is displayed virtually but in the display screen currently displayed virtually as shown, for example in FIG. 24.

Thereby, it is possible to switch from the information of the display screen of the application displayed virtually to the display screen of the actually started application smoothly and to improve the operability at the time of the start of the application by the user.

In addition, it is desirable if the information of the display screen of the application stored in the storage unit 113 when the operation for operating the application by the operation control unit 71 is detected after the first rotation amount was detected by the operation control unit 71 is the information of the starting screen that is first displayed when this application is started.

As such, by making the information of the display screen of the application into the information of the starting screen that is first displayed when this application is started, the user can identify easily whether or not the information of the display screen of any application is displayed virtually.

In addition, when the application control unit 73 ends the new application according to the termination of predetermined processing by the processing unit 70, the control unit 72 controls to display the information of the display screen of the application on the display 21 by referring to the display screen information storage unit 114. At this time, the predetermined processing by the processing unit 70 is call arrival processing, receiving processing of e-mails, or the like, and examples of the new application include an application having a telephone function, an application having a function related to e-mails, or the like.

Moreover, it is desirable if the information of the display screen of the application stored in the display screen information storage unit 114 when the application control unit 73 operated the new application is the information of the display screen of the application that is displayed on the display 21 immediately before the display screen of the new application is displayed.

As such, according to the mobile phone 1 of the present embodiment, when the new application is ended according to the termination of the predetermined processing by the processing unit 70, the information of the display screen of the application is displayed again on the display 21 by referring to the display screen information storage unit 114.

Thereby, when the new application is ended by the termination of call arrival, or the like, the information of the display screen that is displayed before the start of the operation of the new application can be displayed again.

In addition, according to the mobile phone 1 of the present embodiment, when the new application is started, the information of the display screen of the application stored in the display screen information storage unit 114 is made as the information of the display screen of the application that has been displayed on the display 21 immediately before the display screen of this new application was displayed. Thereby, the user can identify easily that the information of the display screen of the application displayed again is of the information of the display screen of which application.

The display control unit 74 displays on the display 21 the display screen corresponding to the predetermined application started by the application control unit 73. In addition, the display control unit 74 displays on the display 21 the information of the display screen transmitted from the control unit 72.

Next, the flow of processing of the mobile phone 1 of the present embodiment will be described with reference to FIG. 25 to FIG. 27. FIG. 25 is a sequence diagram showing the flow of processing by the mobile phone 1 of the present embodiment. In addition, in the sequence diagram shown in FIG. 25, it is premised on Application A running in advance.

In step S401, the operation control unit 71 detects the rotation amount at the rotary dial unit 41.

In step S402, the control unit 72 receives the rotation amount at the rotary dial unit 41 detected by the operation control unit 71.

In step S403, the control unit 72 requests the information of the starting screen of Application B from the memory 112, when the rotation amount received in step S403 is a rotation for selecting Application B.

In step S404, the control unit 72 acquires the information of the starting screen of Application B from the memory 112.

In step S405, the control unit 72 transmits information of the starting screen of Application B acquired in step S404, and requests to display the information of the starting screen of Application B on the display control unit 74 instead of the information of the starting screen of Application A that has been started in advance as well. Then, the information of the starting screen of Application B is displayed on the display 21 by the display control unit 74.

In step S406, the operation control unit 71 detects a different rotation amount from the rotation amount detected by the rotary dial unit 41 in step S401.

In step S407, the control unit 72 receives the rotation amount in the rotary dial unit 41 detected by the operation control unit 71.

In step S408, the control unit 72 requests the information of the starting screen of Application C from the memory 112 when the rotation amount received in step S407 is a rotation amount for selecting Application C.

In step S409, the control unit 72 acquires the information of the starting screen of Application C from the memory 112.

In step S410, the control unit 72 transmits the information of the starting screen of Application C acquired in step S409 to the display control unit 74, and requests to display the information of the starting screen of Application C instead of the information of the starting screen of Application B transmitted in step S405. Then, the information of the starting screen of Application C is displayed on the display 21 by the display control unit 74.

In step S411, the operation control unit 71 detects the operation for starting Application C by the operation key group 11 when the information of the starting screen of Application C is displayed on the display 21.

In step S412, the application control unit 73 receives the operation for starting Application C detected by the operation control unit 71.

In step S413, the application control unit 73 suspends Application A that had been started.

In step S414, the application control unit 73 receives notice from Application A that the suspension has been completed.

In step S415, the application control unit 73 requests the start to Application C stored in the memory 112 according to the operation for starting Application C detected in step S411.

In step S416, the application control unit 73 receives notice from Application C that the starting has been completed.

In step S417, the application control unit 73 transmits to the display control unit 74 the information of the starting screen of Application C according to the operation detected in step S411 not the information of the starting screen of Application C already displayed, and requests that the starting screen displayed based on this information to be displayed.

As such, while displaying the information of the display screen on the display 21 virtually, when the operation for executing the application corresponding to the information of this display screen is detected, the application corresponding to the information of this display screen and not the information of the display screen that was displayed virtually is started, and the display screen when operating the application by the operation of the operation key group 11 can be displayed in the display screen that is displayed virtually.

FIG. 26 is a sequence diagram showing the flow of processing by the mobile phone 1 of the present embodiment. In the sequence diagram shown in FIG. 26, instead of the operation key group 11 shown in FIG. 25, the processing in the communication processing unit 62 will be described.

Since the processing of step S421 to step S425 is the same as the processing in step S401 to step S405 described in FIG. 25, the description is omitted.

In step S426, the communication processing unit 62 notifies that call arrival was detected and call arrival was detected to the application control unit 73.

In step S427, the application control unit 73 starts the interruption processing to the control unit 72 according to the notice of detection of the call arrival by the communication processing unit 62.

In step S428, the control unit 72 makes the display screen information storage unit 114 store temporarily the information of the starting screen of Application B transmitted to the display control unit 74 in step S425 according to the interruption processing by the application control unit 73.

In step S429, the application control unit 73 suspends Application A that had been started.

In step S430, the application control unit 73 receives notice from Application A that suspension has been completed.

In step S431, the application control unit 73 requests starting from Application C having a telephone function.

In step S432, the application control unit 73 receives notice from Application C that the starting has been completed.

In step S433, the application control unit 73 transmits the information for displaying the information of the starting screen of Application C to the display control unit 74, and it is required that a starting screen should be displayed based on this information. Then, Application C having a telephone function starts and the display control unit 74 displays the information of the starting screen of Application C on the display 21.

In step S434, the communication processing unit 62 detects that call arrival was completed, and notifies that call arrival was completed to the application control unit 73.

In step S435, the application control unit 73 notifies termination of interruption processing to the control unit 72 according to the notice of call arrival having been completed.

In step S436, the control unit 72 requests the information of the starting screen of Application B that is stored temporarily in step S428 to the memory 112.

In step S437, the control unit 72 acquires the information of the starting screen of Application B from the memory 112.

In step S438, the control unit 72 transmits the information of the starting screen of Application B acquired in step S437 to the display control unit 74, and requests to transmit to the display control unit 74 the information for displaying the information of the starting screen of Application B on the display 21 instead of the information of the starting screen of Application C transmitted in step S433, and to display the information of the starting screen of Application B.

In step S439, the control unit 72 requests termination of Application C having a telephone function according to the terminating notice of the arrival in step S434.

In step S440, the control unit 72 receives the notice which the termination from Application C completed.

In step S441, the control unit 72 requests the reactivation of Application A that had been suspended in step S429 and step S430 of Application A.

In step S442, the control unit 72 receives notice from Application A that the reactivation has been completed.

As such, according to the mobile phone 1 of the present embodiment, when the new application is ended by the termination of call arrival and the like, the information of the display screen that is displayed before the start of the operation of the new application can be displayed again.

FIG. 27 is a flow chart showing the flow of processing of the mobile phone 1 of the present embodiment. Here, in the flow chart in FIG. 27, it is in the state where the application has been started in advance, and the information of the starting screen of the application other than the application that has been started is displayed on the display 21.

In step S451, the operation control unit 71 determines whether or not the rotary dial unit 41 has the rotation amount for selecting the predetermined application. If it has a rotation amount for selecting the predetermined application (Yes), the process proceeds to step S452. Meanwhile, if it does not have a rotation amount for selecting predetermined application, the process proceeds to step S454 (No).

In step S452, the control unit 72 acquires the information of the starting screen of the application according to the rotation amount detected by the rotary dial unit 41.

In step S453, the display control unit 74 controls to display on the display 21 the information of the starting screen acquired in step S452.

In step S454, the operation control unit 71 determines whether or not the operation to start the application was performed in fixed time after the information of the starting screen is displayed on the display 21 by the operation key group 11. When the operation of starting the application is performed (Yes), the process proceeds to step S455. Meanwhile, when the operation of starting the application has not been performed, the process proceeds to step S458 (No).

In step S455, the application control unit 73 controls to suspend the running application.

In step S456, the application control unit 73 starts the new application where the information of the starting screen is displayed on the display 21.

In step S457, the display control unit 74 displays on the display 21 the information of the display screen of the application started in step S456. At this time, the information of the display screen displayed on the display 21 is information displayed when operating the application according to the operation by the operation key group 11 from the starting screen.

In step S458, the application control unit 73 determines whether or not the interruption processing upon the call arrival, the receipt of e-mails or the like by the communication processing unit 62 has been executed. When the interruption processing has been executed (Yes), the process proceeds to step S459. Meanwhile, when the interruption processing has not been executed, the process proceeds to step S459 (No).

In step S459, the application control unit 73 brings the display screen information storage unit 114 to store temporarily the information of the starting screen of the new application where the information of the starting screen is displayed on the display 21.

In step S460, the application control unit 73 suspends the application that is running.

In step S461, the application control unit 73 starts the application (for example, application having a telephone function when the interrupting processing is call arrival processing) corresponding to the interruption processing.

In step S462, the display control unit 74 controls to display the information of the screen of the application started in step S461 on the display 21.

In step S463, the application control unit 73 determines whether or not the interruption processing performed in step S458 is completed. When the interruption processing is completed (Yes), the process proceeds to step S464. Meanwhile, when the interruption processing is completed, a series of processing are ended (No).

In step S464, the application control unit 73 refers to the display screen information storage unit 114 in step S459, reads the information of the starting screen of the application temporarily stored, and transmits it to the display control unit 74.

In step S465, the display control unit 74 controls to display on the display 21 the starting screen transmitted from the application control unit 73 in step S464.

In step S466, the application control unit 73 ends the application that was executing the interruption processing.

In step S467, the application control unit 73 starts the application suspended in step S460.

Although one embodiment of the present invention has been described above, the present invention is not limited to the embodiment described above, and can be changed as appropriate. When the rotation amount for selecting the application in the rotary dial unit 41 is detected by the operation control unit 71 in the embodiment described above, in the mobile phone 1, although the control unit 72 controls to refer to the storage unit 113, to acquire the information of the display screen of the application, and to display a display screen on the display 21 based on the acquired information, but is not limit to this.

For example, when the operation (first operation) for selecting the application in the operation key group 11 is detected by the operation control unit 71, the control unit 72 may control to display the display screen on the display 21 by referring to the storage unit 113 using the acquired information of the display screen of the application.

Thereby, based on the operation for selecting the application in the operation key group 11 and not only in the rotary dial unit 41, it is possible to acquire the information of the display screen of the application, and display the display on the display 21 based on the acquired information.

At this time, when the operation (second operation) for performing the application is detected after the operation for selecting the application is detected by the operation control unit 71, the application control unit 73 may be controlled to start this application by removing the information of the display screen out of the application.

As such, based on the operation for selecting the application in the rotary dial unit 41 and not limiting to the operation key group 11, it is possible to switch the information of the display image that is displayed on the display 21 smoothly from the information of the display screen of the virtually displayed application to the display screen of the actually started application and to improve the usability at the time of the start of the application.

In addition, although the control unit 72 is controlled to display the information of the display screen in all the applications in the embodiment described above, the present invention is not limited to this. For example, the application that needs time for starting and the application that does not need time for starting are stored in the memory 112 by classifying them in advance. Moreover, the control unit 72 may control to refer to the memory 112, display the information of the starting screen only to the application that needs time for starting, and actually start the application of the application that does not need time for starting.

Thereby, the operability at the time of the start of the application by the user can be improved and the load of the processing at the time of the start of the application by the processing unit 70 can be reduced as well.

It should be noted that although the mobile phone 1 is described in the embodiment described above, the present invention is not limited to this, and for example, it may be a PHS (registered trademark: Personal Handy phone System), a PDA (Personal Digital Assistant), a portable navigation device, a portable personal computer such as a notebook PC, or the like.

### EXPLANATION OF REFERENCE NUMERALS

1 mobile phone
2 operation unit side housing portion
3 display unit side housing portion
4 hinge mechanism
11 operation key group (input operation unit)
21 display
41 rotary dial unit (external operation unit)
70 processing unit
71 operation control unit
72 control unit
73 application control unit
113 storage unit
114 display screen information storage unit
201 application execution unit
202 operation unit (operation means)
203 operation control unit (operation control means)
204 display control unit
205 rotation amount detection unit
206 application starting processing unit
207 application execution determination unit

1. A mobile electronic device, comprising:
an application execution unit;
an operation means having an input operation unit and an external operation unit; and
an operation control means for controlling various processing associated with operation by the operation means; wherein
when a predetermined application is being executed by the application execution unit, the operation control means assigns processing functions related to the predetermined application to a plurality of setting positions in the external operation unit; and
when an input by the input operation unit is detected at a time when the predetermined application is being executed, the application execution unit executes the processing function assigned to the predetermined setting position in the external operation unit.

2. The mobile electronic device according to claim 1, comprising
a display control unit for controlling a display unit, wherein
when a predetermined application is being executed by the application execution unit, the display control unit displays display information related to the processing function assigned to the external operation unit.

3. The mobile electronic device according to claim 1, wherein
information related to the processing function assigned to the predetermined application is displayed on an external surface of the external operation unit.

4. The mobile electronic device according to claim 1, comprising
a display unit, wherein
when the predetermined application is being executed, the operation control means assigns a processing function corresponding to an image displayed on the display unit to the setting position of the external operation unit.

5. The mobile electronic device according to claim 1, comprising
a communication unit, wherein
when the predetermined application is being executed and information related to a predetermined other communication party is selected, the operation control means assigns a processing function related to a communications processing performed by the communication unit to the predetermined other communication party to the setting position of the external operation unit.

6. The mobile electronic device according to claim 1, wherein
when an application related to character inputting is being executed, the operation control means assigns a processing function related to character inputting to the setting position of the external operation unit.

7. The mobile electronic device according to claim 1, wherein
in a case where data that has not been saved is handled when a predetermined application is being executed by the application execution unit, the operation control means assigns a processing function related to saving processing of the data to the setting position of the external operation unit.

8. The mobile electronic device according to claim 1, wherein
when a predetermined application is being executed by the application execution unit and data that has been saved is handled, the operation control means assigns a processing function related to utilization processing of the data to the setting position of the external operation unit.

9. The mobile electronic device according to claim 1, wherein
when a predetermined application is being executed by the application execution unit and image data has been handled, the operation control means assigns a processing function related to image editing processing of the image data to the setting position of the external operation unit.

10. A mobile electronic device, comprising:
a housing;
a rotary dial unit attached to the housing rotatably around a predetermined revolving shaft;
a rotation amount detection unit for detecting rotation amount of the rotary dial unit;
an application starting processing unit for determining and starting one application among a plurality of applications based on the rotation detected by the rotation amount detection unit; and
an application execution determination unit for determining whether or not the application determined by the application starting processing unit has been executed; wherein
when it is determined by the application execution determination unit that the application determined by the application starting processing unit has been executed already, the application starting processing unit stops the start of the application.

11. The mobile electronic device according to claim 10, wherein
in a case where it is determined by the application execution determination unit that the application determined by the application starting processing unit is running in background when a plurality of the applications are running,
the application starting processing unit stops the start of the application, switches the application that is running in background to run in foreground, and switches another application that had been running in foreground to run in background.

12. A mobile electronic device, comprising:
an operation unit;
a display unit;
an operation detection unit for detecting operation of the operation unit;
a storage unit for storing information of a display screen for each application that is displayed on the display unit; and
a control unit for controlling, when a first operation for selecting the application is detected by the operation detection unit, to acquire information of the display screen of the application by referring to the storage unit and to display the display screen on the display unit with the acquired information.

13. The mobile electronic device according to claim 12, further comprising
an application control unit for controlling, when a second operation for starting the application is detected after the first operation has been detected by the operation detection unit, to start the application by removing information of the display screen from the application.

14. The mobile electronic device according to claim 12, wherein
the information of the display screen of the application that is stored in the storage unit is information of a starting screen that is displayed when the application is started.

15. A mobile electronic device, comprising:
a housing;
a display unit arranged at the housing;
a rotary dial unit which is arranged at the housing and is rotatable around a predetermined revolving shaft;
a rotation amount detection unit for detecting a rotation amount of the rotary dial unit;
a storage unit for storing information of a display screen for each application that is displayed on the display unit; and
a control unit for controlling, when a first rotation amount for selecting the application is detected by the rotation amount detection unit, to acquire information of the display screen of the application by referring to the storage unit and to display on the display unit the acquired information of the display screen.

16. The mobile electronic device according to claim 15, comprising:
an operation unit;
an operation detection unit for detecting operation of the operation unit; and
an application control unit for controlling, when a third operation for operating the application is detected by the operation detection unit after the first rotation amount is detected by the rotation amount detection unit, to operate the application by removing information of the display screen from the application.

17. The mobile electronic device according to claim 16, wherein
the information of the display screen of the application that is stored in the storage unit when the third operation is detected is information of a starting screen that is displayed first when the application is started.

18. The mobile electronic device according to claim 16, further comprising:
a display screen information storage unit for storing temporarily information of the display screen displayed on the display; and
a processing unit for performing predetermined processing; wherein
the application control unit operates a new application according to the predetermined processing by the processing unit, and
the control unit displays on the display unit information of a display screen of the new application instead of information of the display screen of the application according to the operation of the new application, and stores information of the display screen of the application in the display screen information storage unit.

19. The mobile electronic device according to claim 18, wherein
when the application control unit terminates the new application in response to terminating the predetermined processing by the processing unit,
the control unit displays on the display unit information of the display screen of the application by referring to the display screen information storage unit.

20. The mobile electronic device according to claim 19, wherein
when the application control unit operates the new application, the information of the display screen of the application that is stored in the display screen information storage unit is information of a display screen of the application that had been displayed on the display unit immediately before the display screen of the new application is displayed.
